(19) United States
(12) Patent Application Publication
(10) Pub. No.: US 2013/0055143 A1
(43) Pub. Date: Feb. 28, 2013

(54) METHOD FOR MANIPULATING A GRAPHICAL USER INTERFACE AND INTERACTIVE INPUT SYSTEM EMPLOYING THE SAME

(71) Applicants: David Martin, Calgary (CA); Douglas Hill, Calgary (CA); Edward Tse, Calgary (CA); Wendy Segelken, Calgary (CA)

(72) Inventors: David Martin, Calgary (CA); Douglas Hill, Calgary (CA); Edward Tse, Calgary (CA); Wendy Segelken, Calgary (CA)

(73) Assignee: SMART TECHNOLOGIES ULC, Calgary (CA)

(21) Appl. No.: 13/601,429

(22) Filed: Aug. 31, 2012

Related U.S. Application Data
(60) Provisional application No. 61/529,899, filed on Aug. 31, 2011.

(51) Int. Cl. G06F 3/048; G06F 3/033

(52) U.S. Cl. 715/779; 715/863; 715/856; 345/157

(57) ABSTRACT

A method comprises capturing at least one image of a three-dimensional (3D) space disposed in front of a display surface and processing the captured at least one image to detect a pointing gesture made by a user within the three-dimensional (3D) space and the position on the display surface to which the pointing gesture is aimed.

### CROSS-REFERENCE TO RELATED APPLICATIONS

This application claims the benefit of U.S. Provisional Application No. 61/529,899 to Martin et al., filed on Aug. 31, 2011 and entitled “Method for Manipulating a Graphical User Interface and Interactive Input System Employing the Same”, the entire disclosure of which is incorporated herein by reference.

### FIELD OF THE INVENTION

The subject application relates generally to a method for manipulating a graphical user interface (GUI) and to an interactive input system employing the same.

### BACKGROUND OF THE INVENTION

Interactive input systems that allow users to inject input such as for example digital ink, mouse events, etc., into an application program using an active pointer (e.g., a pointer that emits light, sound or other signal), a passive pointer (e.g., a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 6,972,401; 7,232,986; 7,236,162; and 7,274,356 and in U.S. Patent Application Publication No. 2004/0179001, all assigned to SMART Technologies ULC of Calgary, Alberta, Canada, assignee of the subject application, the entire disclosures of which are incorporated herein by reference; touch systems comprising touch panels employing electromagnetic, capacitive, acoustic or other technologies to register pointer input; tablet and laptop personal computers (PCs); personal digital assistants (PDAs) and other handheld devices; and other similar devices.

During operation of an interactive input system of the types discussed above, the interactive input system may be conditioned to an ink mode, in which case a user may use a pointer to inject digital ink into a computer desktop or application window. Alternatively, the interactive input system may be conditioned to a cursor mode, in which case the user may use the pointer to initiate commands to control the execution of computer applications by registering contacts of the pointer on the interactive surface as respective mouse events. For example, a tapping of the pointer on the interactive surface (i.e., the pointer quickly contacting and then lifting up from the interactive surface) is generally interpreted as a mouse-click event that is sent to the application window at the pointer contact location.

Although interactive input systems are useful in some situations problems may arise. For example, when a user uses an interactive input system running a Microsoft® PowerPoint® software application to present slides in the presentation mode, an accidental pointer contact on the interactive surface may trigger the Microsoft® PowerPoint® application to unintentionally forward the presentation to the next slide.

During collaboration meetings, that is, when an interactive input system is used to present information to remote users, e.g., by sharing the display of the interactive input system, remote users do not have clear indication of where the presenter is pointing to on the display. Although pointer contacts on the interactive surface generally move the cursor shown on the display to the pointer contact location, the movement of the cursor may not provide enough indication because of its small size. Moreover, when the presenter points to a location of the display without contacting the interactive surface, or when the presentation software application hides the cursor during the presentation, remote users will not receive any indication of where the presenter is pointing.

As a result, improvements in interactive input systems are sought. It is therefore an object to at least to provide a novel method for manipulating a graphical user interface (GUI) and an interactive input system employing the same.

### SUMMARY OF THE INVENTION

Accordingly, in one aspect there is provided a method comprising capturing at least one image of a three-dimensional (3D) space disposed in front of a display surface; and processing the captured at least one image to detect a pointing gesture made by a user within the three-dimensional (3D) space and the position on the display surface to which the pointing gesture is aimed.

According to another aspect there is provided an interactive input system comprising a display surface; at least one imaging device configured to capture images of a three-dimensional (3D) space disposed in front of the display surface; and processing structure configured to process the captured images to detect a user making a pointing gesture towards the display surface and the position on the display surface to which the pointing gesture is aimed.

According to another aspect there is provided a method of manipulating a graphical user interface (GUI) displayed on a display surface comprising receiving an input event from an input device; processing the input event to determine the location of the input event and the type of the input event; comparing at least one of the location of the input event and the type of the input event to defined criteria; and manipulating the GUI based on the result of the comparing.

According to another aspect there is provided an interactive input system comprising a display surface on which a graphical user interface (GUI) is displayed; at least one input device; and processing structure configured to receive an input event from the at least one input device, determine the location of the input event and the type of the input event, compare at least one of the location of the input event and the type of the input event to defined criteria, and manipulate the GUI based on the result of the comparing.

According to another aspect there is provided a method of manipulating a shared graphical user interface (GUI) displayed on a display surface of at least two client devices, one of the client devices being a host client device, the at least two client devices participating in a collaboration session, the method comprising receiving, at the host client device, an input event from an input device associated with an annotator device of the collaboration session; processing the input event to determine the location of the input event and the type of the input event; comparing at least one of the location of the input event and the type of the input event to defined criteria; and manipulating the shared GUI based on the results of the comparing.

According to another aspect there is provided a method of applying an indicator to a graphical user interface (GUI) displayed on a display surface, the method comprising receiving an input event from an input device; determining characteristics of said input event, the characteristics comprising at least one of the location of the input event and the type of the input event; determining if the characteristics of the input event satisfies defined criteria; and manipulating the GUI if the defined criteria is satisfied.

According to another aspect there is provided a method of processing an input event comprising receiving an input event from an input device; determining characteristics of the input event, the characteristics comprising at least one of the location of the input event and the type of the input event; determining an application program to which the input event is to be applied; determining whether the characteristics of the input event satisfies defined criteria; and sending the input event to the application program if the defined criteria is satisfied.

### BRIEF DESCRIPTION OF THE DRAWINGS

Embodiments will now be described more fully with reference to the accompanying drawings in which:

FIG. 1 is a perspective view of an interactive input system.

FIG. 2 is a schematic block diagram showing the software architecture of a general purpose computing device forming part of the interactive input system of FIG. 1.

FIG. 3 shows an exemplary graphical user interface (GUI) displayed on the interactive surface of an interactive whiteboard forming part of the interactive input system of FIG. 1.

FIG. 4 is a flowchart showing an input event processing method employed by the interactive input system of FIG. 1.

FIGS. 5 to 14 show examples of manipulating a graphical user interface presented on the interactive surface of the interactive whiteboard according to the input event processing method of FIG. 4.

FIG. 15 is a perspective view of another embodiment of an interactive input system.

FIG. 16 is a schematic block diagram showing the software architecture of each client device forming part of the interactive input system of FIG. 15.

FIG. 17 is a flowchart showing an input event processing method performed by an annotator forming part of the interactive input system of FIG. 15.

FIG. 18 illustrates the architecture of an update message

FIG. 19 is a flowchart showing an input event processing method performed by a host forming part of the interactive input system of FIG. 15.

FIG. 20 is a flowchart showing a display image updating method performed by the annotator.

FIG. 21 is a flowchart showing a display image method performed by a viewer forming part of the interactive input system of FIG. 15.

FIGS. 22 and 23 illustrate an exemplary GUI after processing an input event.

FIGS. 24 and 25 are perspective and side elevational views, respectively, of an alternative interactive whiteboard.

FIGS. 26 and 27 show examples of manipulating a GUI presented on the interactive surface of the interactive whiteboard of FIGS. 24 and 25.

FIGS. 28 and 29 are perspective and side elevational views, respectively, of another alternative interactive whiteboard.

FIGS. 30 and 31 show examples of manipulating a GUI presented on the interactive surface of the interactive whiteboard of FIGS. 28 and 29.

FIG. 32 is a perspective view of yet another embodiment of an interactive whiteboard.

FIG. 33 is a flowchart showing a method for processing an input event generated by a range imaging device of the interactive whiteboard of FIG. 32.

FIG. 34 shows two users performing pointing gestures toward the interactive whiteboard of FIG. 32.

FIG. 35 shows a single user performing a pointing gesture towards the interactive whiteboard of FIG. 32.

FIG. 36 illustrates an exemplary display surface associated with a client device connected to a collaborative session hosted by the interactive whiteboard of FIG. 32 after the pointing gesture of FIG. 35 has been detected.

FIG. 37 illustrates the architecture of an alternative update message.

FIG. 38 illustrates the interactive surface of an interactive whiteboard forming part of yet another alternative interactive input system.

FIG. 39 illustrates the interactive surface of an interactive whiteboard forming part of yet another alternative interactive input system.

FIG. 40 illustrates the interactive surface of an interactive whiteboard forming part of still yet another alternative interactive input system.

### DETAILED DESCRIPTION OF THE EMBODIMENTS

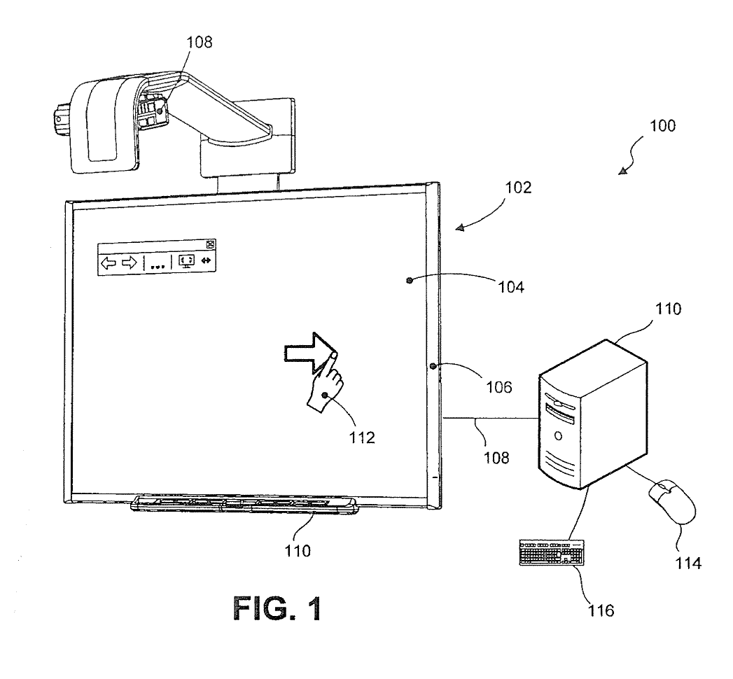

Turning now to FIG. 1, an interactive input system is shown and is generally identified by reference numeral 100. Interactive input system 100 allows a user to inject input such as digital ink, mouse events, commands, etc., into an executing application program. In this embodiment, interactive input system 100 comprises a two-dimensional (2D) interactive device in the form of an interactive whiteboard (IWB) 102 mounted on a vertical support surface such as for example, a wall surface or the like. IWB 102 comprises a generally planar, rectangular interactive surface 104 that is surrounded about its periphery by a bezel 106. A short-throw projector 108 such as that sold by SMART Technologies ULC of Calgary, Alberta under the name “SMART Unifi 45” is mounted on the support surface above the IWB 102 and projects an image, such as for example, a computer desktop, onto the interactive surface 104.

The IWB 102 employs machine vision to detect one or more pointers brought into a region of interest in proximity with the interactive surface 104. The IWB 102 communicates with a general purpose computing device 110 executing one or more application programs via a universal serial bus (USB) cable 108 or other suitable wired or wireless communication link. General purpose computing device 110 processes the output of the IWB 102 and adjusts screen image data that is output to the projector 108, if required, so that the image presented on the interactive surface 104 reflects pointer activity. In this manner, the IWB 102, general purpose computing device 110 and projector 108 allow pointer activity proximate to the interactive surface 104 to be recorded as writing or drawing or used to control execution of one or more application programs executed by the general purpose computing device 110.

The bezel 106 is mechanically fastened to the interactive surface 104 and comprises four bezel segments that extend along the edges of the interactive surface 104. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces lie in a plane generally normal to the plane of the interactive surface 104.

A tool tray 110 is affixed to the IWB 102 adjacent the bottom bezel segment using suitable fasteners such as for example, screws, clips, adhesive, friction fit, etc. As can be seen, the tool tray 110 comprises a housing having an upper surface configured to define a plurality of receptacles or slots. The receptacles are sized to receive one or more pen tools (not shown) as well as an eraser tool (not shown) that can be used to interact with the interactive surface 104. Control buttons are also provided on the upper surface of the tool tray housing to enable a user to control operation of the interactive input system 100 as described in U.S. Patent Application Publication No. 2011/0169736 to Bolt et al., filed on Feb. 19, 2010, and entitled “INTERACTIVE INPUT SYSTEM AND TOOL TRAY THEREFOR”.

Imaging assemblies (not shown) are accommodated by the bezel 106, with each imaging assembly being positioned adjacent a different corner of the bezel. Each of the imaging assemblies comprises an image sensor and associated lens assembly that provides the image sensor with a field of view sufficiently large as to encompass the entire interactive surface 104. A digital signal processor (DSP) or other suitable processing device sends clock signals to the image sensor causing the image sensor to capture image frames at the desired frame rate. During image frame capture, the DSP also causes an infrared (IR) light source to illuminate and flood the region of interest over the interactive surface 104 with IR illumination. Thus, when no pointer exists within the field of view of the image sensor, the image sensor sees the illumination reflected by the retro-reflective bands on the bezel segments and captures image frames comprising a continuous bright band. When a pointer exists within the field of view of the image sensor, the pointer occludes IR illumination and appears as a dark region interrupting the bright band in captured image frames.

The imaging assemblies are oriented so that their fields of view overlap and look generally across the entire interactive surface 104. In this manner, any pointer 112 such as for example a user's finger, a cylinder or other suitable object, a pen tool or an eraser tool lifted from a receptacle of the tool tray 110, that is brought into proximity of the interactive surface 104 appears in the fields of view of the imaging assemblies and thus, is captured in image frames acquired by multiple imaging assemblies. When the imaging assemblies acquire image frames in which a pointer exists, the imaging assemblies convey pointer data to the general purpose computing device 110. With one imaging assembly installed at each corner of the interactive surface 104, the IWB 102 is able to detect multiple pointers brought into proximity of the interactive surface 104.

The general purpose computing device 110 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computing device components to the processing unit. The general purpose computing device 110 may also comprise networking capabilities using Ethernet, WiFi, and/or other suitable network format, to enable connection to shared or remote drives, one or more networked computers, or other networked devices. A mouse 114 and a keyboard 116 are coupled to the general purpose computing device 110.

The general purpose computing device 110 processes pointer data received from the imaging assemblies to resolve pointer ambiguities and to compute the locations of pointers proximate to the interactive surface 104 using well known triangulation. The computed pointer locations are then recorded as writing or drawing or used as input commands to control execution of an application program.

In addition to computing the locations of pointers proximate to the interactive surface 104, the general purpose computing device 110 also determines the pointer types (e.g., pen tool, finger or palm) by using pointer type data received from the IWB 102. In this embodiment, the pointer type data is generated for each pointer contact by the DSP of at least one of the imaging assemblies by differentiating a curve of growth derived from a horizontal intensity profile of pixels corresponding to each pointer tip in captured image frames. Methods to determine pointer type are disclosed in U.S. Pat. No. 7,532,206 to Morrison et al., and assigned to SMART Technologies ULC, the disclosure of which is incorporated herein by reference in its entirety.

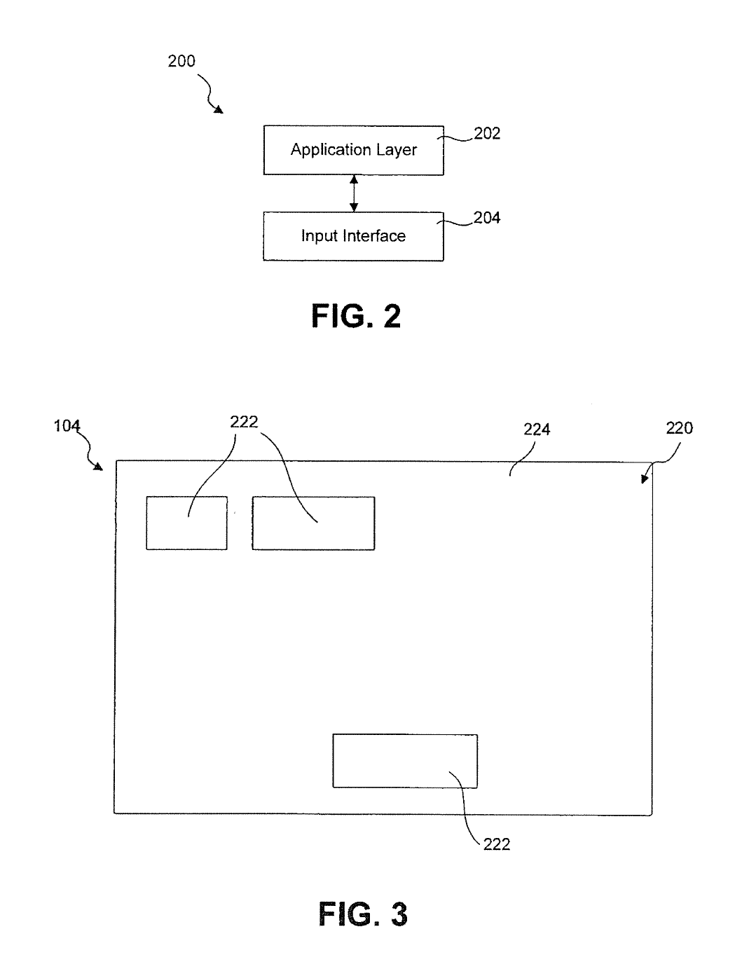

FIG. 2 shows the software architecture 200 of the general purpose computing device 110. The software architecture 200 comprises an application layer 202 comprising one or more application programs and an input interface 204. The input interface 204 is configured to receive input from the input devices associated with the interactive input system 100. In this embodiment, the input devices include the IWB 102, mouse 114, and keyboard 116. The input interface 204 processes each received input to generate an input event and communicates the input event to the application layer 202.

The input interface 204 detects and adapts to the mode of the active application in the application layer 202. In this embodiment, if the input interface 204 detects that the active application is operating in a presentation mode, the input interface 204 analyzes the graphical user interface (GUI) associated with the active application, and partitions the GUI into an active control area and an inactive area, as will be described. If the input interface 204 detects that the active application is not operating in the presentation mode, the active application is assumed to be operating in an editing mode, in which case the entire GUI is designated an active control area.

As will be appreciated, the GUI associated with the active application is at least a portion of the screen image output by the general purpose computing device 110 and displayed on the interactive surface 104. The GUI comprises one or more types of graphic objects such as for example menus, toolbars, buttons, text, images, animations, etc., generated by at least one of an active application, an add-in program, and a plug-in program.

For example, as is well known, the GUI associated with the Microsoft® PowerPoint® application operating in the editing mode is a PowerPoint® application window comprising graphic objects such as for example a menu bar, a toolbar, page thumbnails, a canvas, text, images, animations, etc. The toolbar may also comprise tool buttons associated with plug-in programs such as for example the Adobe Acrobat® plug-in. The GUI associated with the Microsoft® PowerPoint® application operating in the presentation mode is a full screen GUI comprising graphic objects such as for example text, images, animations, etc., presented on a presentation slide. In addition to the full screen GUI, a toolbar generated by an add-in program such as for example a tool bar generated by the SMART Aware™ plug-in is overlaid on top of the full page GUI and comprises one or more buttons for controlling the operation of the Microsoft® PowerPoint® application operating in the presentation mode.

A set of active graphic objects is defined within the general purpose computing device 110 and includes graphic objects in the form of a menu, toolbar, buttons, etc. The set of active graphic objects is determined based on, for example, which graphic objects, when selected, perform a significant update, such as for example forwarding to the next slide in the presentation, on the active application when operating in the presentation mode. In this embodiment, the set of active graphic objects comprises toolbars. Once the active application is set to operate in the presentation mode, any graphic object included in the set of active graphic objects becomes part of the active control area within the GUI. All other areas of the GUI displayed during operation of the active application in the presentation mode become part of the inactive area. The details of the active control area and the inactive area will now be described.

An exemplary GUI displayed on the interactive surface 104 in the event the active application in the application layer 202 is operating in the presentation mode is shown in FIG. 3 and is generally identified by reference numeral 220. As can be seen, the GUI 220 is partitioned into an active control area 222 and an inactive area 224. In this example, the active control area 222 comprises three (3) separate graphic objects, which are each of a type included in the set of active graphic objects described above. The inactive area 224 is generally defined by all other portions of the GUI, that is, all locations other than those associated with the active control area 222. The general purpose computing device 110 monitors the location of the active graphic objects, and updates the active control area 222 in the event that a graphic object is moved to a different location.

Once an input event is received, the input interface 204 checks the source of the input event. If the input event is received from the IWB 102, the location of the input event is calculated. For example, if a touch contact is made on the interactive surface 104 of the IWB 102, the touch contact is mapped to a corresponding location on the GUI. After mapping the location of the touch contact, the input interface 204 determines if the mapped position of the touch contact corresponds to a location within the active control area 222 or inactive area 224. In the event the position of the touch contact corresponds to a location within the active control area 222, the control associated with the location of the touch contact is executed. In the event the position of the touch contact corresponds to a location within the inactive area 224, the touch contact results in no change to the GUI and/or results in a pointer indicator being presented on the GUI at a location corresponding to the location of the touch contact. If the input event is received from the mouse 114, the input interface 204 does not check if the location of the input event corresponds to a position within the active control area 222 or the inactive area 224, and sends the input event to the active application.

In the following examples, the active application in the application layer 202 is the Microsoft® PowerPoint® 2010 software application. An add-in program to Microsoft® PowerPoint® is installed, and communicates with the input interface 204. The add-in program detects the state of the Microsoft® PowerPoint® application by accessing the Application Interface associated therewith, which is defined in Microsoft® Office and represents the entire Microsoft® PowerPoint® application to check whether a SlideShowBegin event or SlideShowEnd event has occurred. A SlideShowBegin event occurs when a slide show starts (i.e., the Microsoft® PowerPoint® application enters the presentation mode), and a SlideShowEnd event occurs after a slide show ends (i.e., the Microsoft® PowerPoint® application exits the presentation mode). Further information of the Application Interface and SlideShowBegin and SlideShowEnd events can be found in the Microsoft® MSDN library at <http://msdn.microsoft.com/en-us/library/ff764034.aspx>.

In the event that an input event is received from the IWB 102 (hereinafter referred to as a “touch input event”), the touch input event is processed and compared to a set of predefined criteria, and when appropriate, a temporary or permanent indicator is applied to the GUI displayed on the interactive surface 104. A temporary indicator is a graphic object which automatically disappears after the expiration of a defined period of time. A counter/timer is used to control the display of the temporary indicator, and the temporary indicator disappears with animation (e.g., fading-out, shrinking, etc.) or without animation, depending on the system settings. A permanent indicator, on the other hand, is a graphic object that is permanently displayed on the interactive surface 104 until a user manually deletes the permanent indicator (e.g., by popping up a context menu on the permanent indicator when selected by the user, wherein the user can then select “Delete”). The details regarding the processing of an input event received from an input device will now be described.

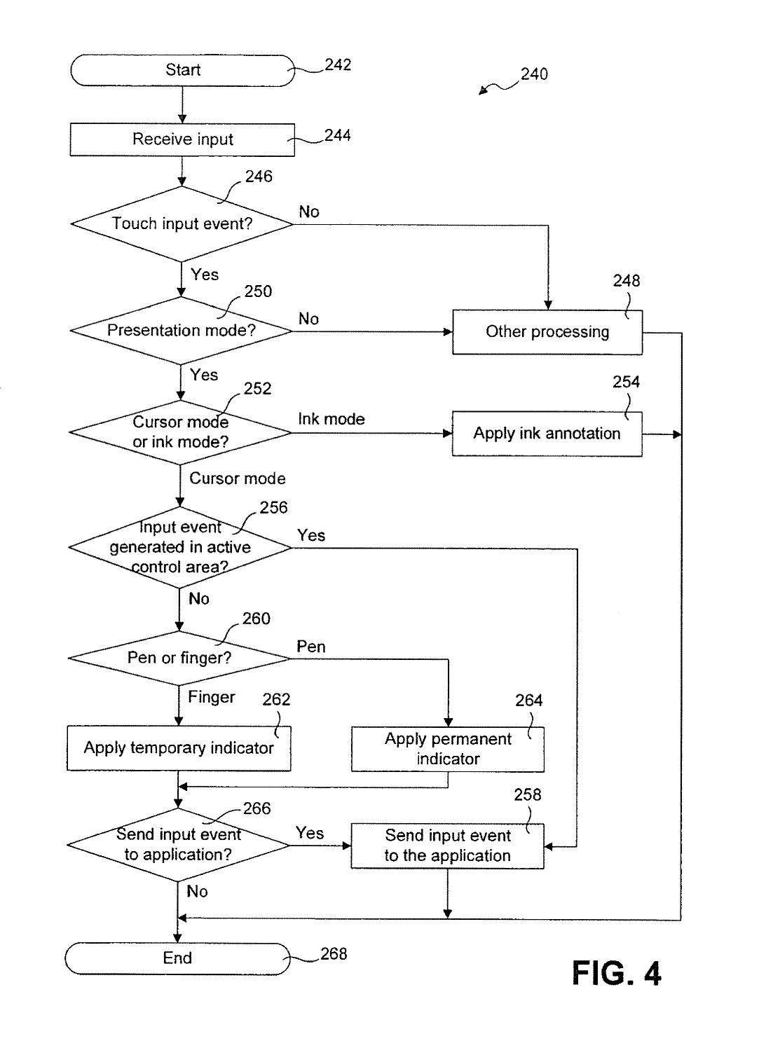

Turning now to FIG. 4, a method executed by the input interface 204 for processing an input event received from an input device is shown and is generally identified by reference numeral 240. The method begins when an input event is generated from an input device and communicated to the input interface 204 (step 242). As will be appreciated, it is assumed that the input event is applied to the active application. The input interface 204 receives the input event (step 244) and determines if the input event is a touch input event (step 246).

If the input event is not a touch input event, the input event is sent to a respective program (e.g., an application in the application layer 202 or the input interface 204) for processing (step 248), and the method ends (step 268).

If the input event is a touch input event, the input interface 204 determines if the active application is operating in the presentation mode (step 250). As mentioned previously, the Microsoft® PowerPoint® application is in the presentation mode if the add-in program thereto detects that a SlideShowBegin event has occurred.

If the active application is not operating in the presentation mode, the touch input event is sent to a respective program for processing (step 248), and the method ends (step 268). If the active application is operating in the presentation mode, the input interface 204 determines if the pointer associated with the touch input event is in an ink mode or a cursor mode (step 252).

If the pointer associated with the touch input event is in the ink mode, the touch input event is recorded as writing or drawing by a respective program (step 254) and the method ends (step 268).

If the pointer associated with the touch input event is in the cursor mode, the input interface 204 determines if the touch input event was made in the active control area of the GUI of the active application (step 256). If the touch input event was made in the active control area of the GUI of the active application, the touch input event is sent to the active application for processing (step 258), and the method ends (step 268).

If the touch input event was not made in the active control area of the GUI of the active application, it is determined that the touch input event was made in the inactive area and the input interface 204 determines if the pointer associated with the touch input event is a pen or a finger (step 260). If the pointer associated with the touch input event is a finger, the input interface 204 causes a temporary indicator to be displayed at the location of the touch input event (step 262).

If the pointer associated with the touch input event is a pen, the input interface 204 causes a permanent indicator to be displayed at the location of the touch input event (step 264).

The input interface 204 then determines if the touch input event needs to be sent to an active application, based on rules defined in the input interface 204 (step 266). In this embodiment, a rule is defined that prohibits a touch input event from being sent to the active application if the touch input event corresponds to a user tapping on the inactive area of the active GUI. The rule identifies “tapping” if a user contacts the interactive surface 104 using a pointer, and removes it from contact with the interactive surface 104 within a defined time threshold such as for example 0.5 seconds. If the touch input event is not to be sent to an active application, the method ends (step 268). If the touch input event is to be sent to an active application, the touch input event is sent to the active application for processing (step 258), and the method ends (step 268).

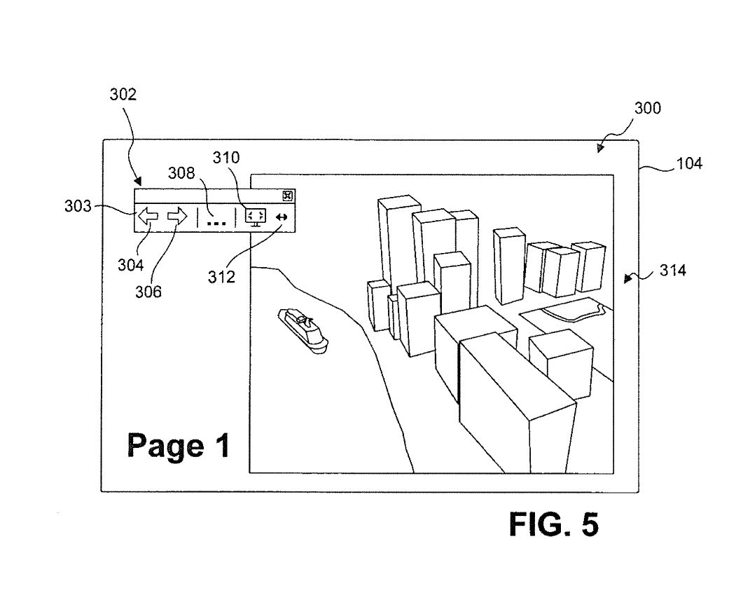

FIGS. 5 to 13 illustrate examples of manipulating a GUI presented on the interactive surface 104 according to method 240. As mentioned previously, in this embodiment, the active application is the Microsoft® PowerPoint® application operating in the presentation mode, and running a presentation that comprises two slides, namely a “Page 1” presentation slide and a “Page 2” presentation slide.

FIG. 5 illustrates the GUI associated with the “Page 1” presentation slide, which is identified by reference numeral 300. As can be seen, GUI 300 is displayed in full-screen mode and thus, the entire interactive surface 104 displays the GUI 300. The GUI 300 is partitioned into an active control area 302 and an inactive area 314, which includes all portions of the GUI 300 that are not part of the active control area 302. In this embodiment, the active control area 302 is in the form of a compact toolbar 303 generated by the SMART Aware™ plug-in overlaid on top of GUI 300 and comprising tool buttons 304 to 312 to permit a user to control the presentation. If tool button 304 is selected, the presentation moves to the previous slide. If tool button 306 is selected, the presentation moves to the next slide. If tool button 308 is selected, a menu is displayed providing additional control functions. If tool button 310 is selected, the presentation mode is terminated. If tool button 312 is selected, the compact tool bar 303 is expanded into a full tool bar providing additional tool buttons.

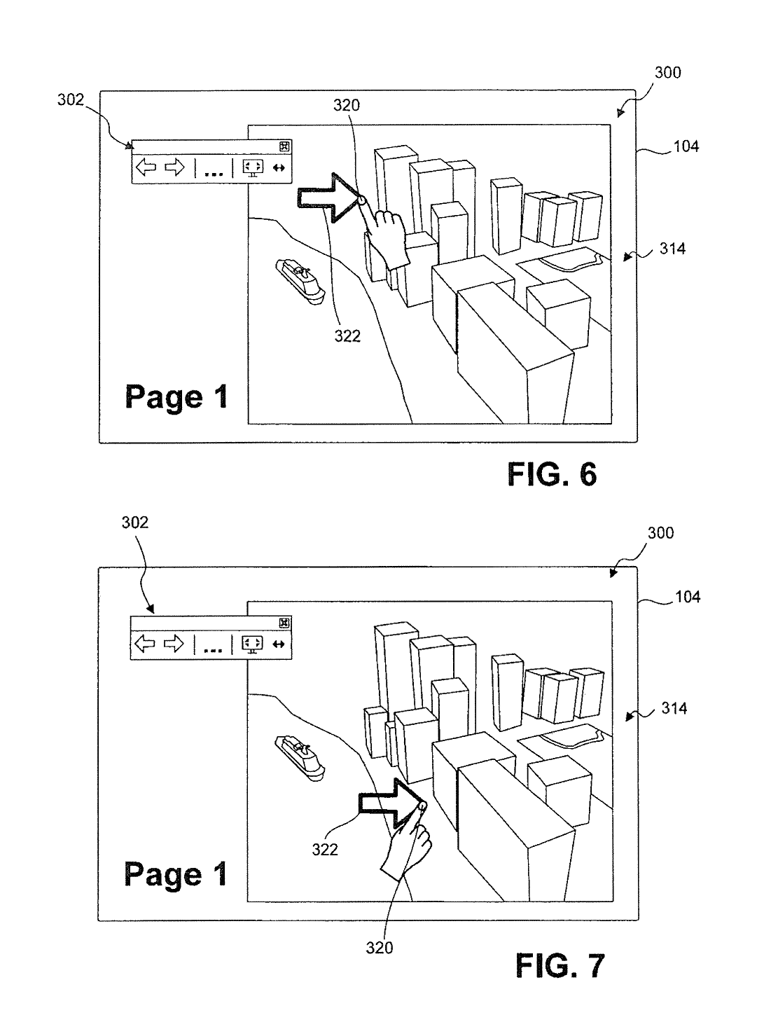

Turning now to FIG. 6, the GUI 300 is shown after processing an input event received from the IWB 102 triggered by a user's finger 320 touching the interactive surface 104 at a location in the inactive area 314. The input event is processed according to method 240, as will now be described.

The input event is generated and sent to the input interface 204 when the finger 320 contacts the interactive surface 104 (step 242). The input interface 204 receives the input event (step 244), and determines that the input event is a touch input event (step 246). The input interface 204 determines that the active application is operating in the presentation mode (step 250) and that the pointer associated with the input event is in the cursor mode (step 252). As can be seen in FIG. 6, the input event is made in the inactive area 314 of the GUI 300 (step 256), and the input interface 204 determines that the pointer associated with the input event is a finger (step 260). Since the input event is made in the inactive area 314 of the GUI 300, and the pointer associated with the input event is a finger, the input interface 204 applies a temporary indicator to GUI 300 at the location of the input event (step 262), which in this embodiment is in the form of an arrow 322. Further, since the input event was made in the inactive area 314, the input event does not need to be sent to the active application (Microsoft® PowerPoint®), and thus the method ends (step 268).

As mentioned previously, the temporary indicator appears on interactive surface 104 for a defined amount of time, such as for example five (5) seconds. Thus, arrow 322 will appear on the interactive surface 104 for a period of five (5) seconds. If, during this period, an input event occurs at another location within the inactive area 314 of the GUI displayed on the interactive surface 104, the arrow 322 is relocated to the location of the most recent input event. For example, as shown in FIG. 7, the user's finger 320 is moved to a new location on the interactive surface 104, and thus the arrow 322 is relocated to the new location on GUI 300.

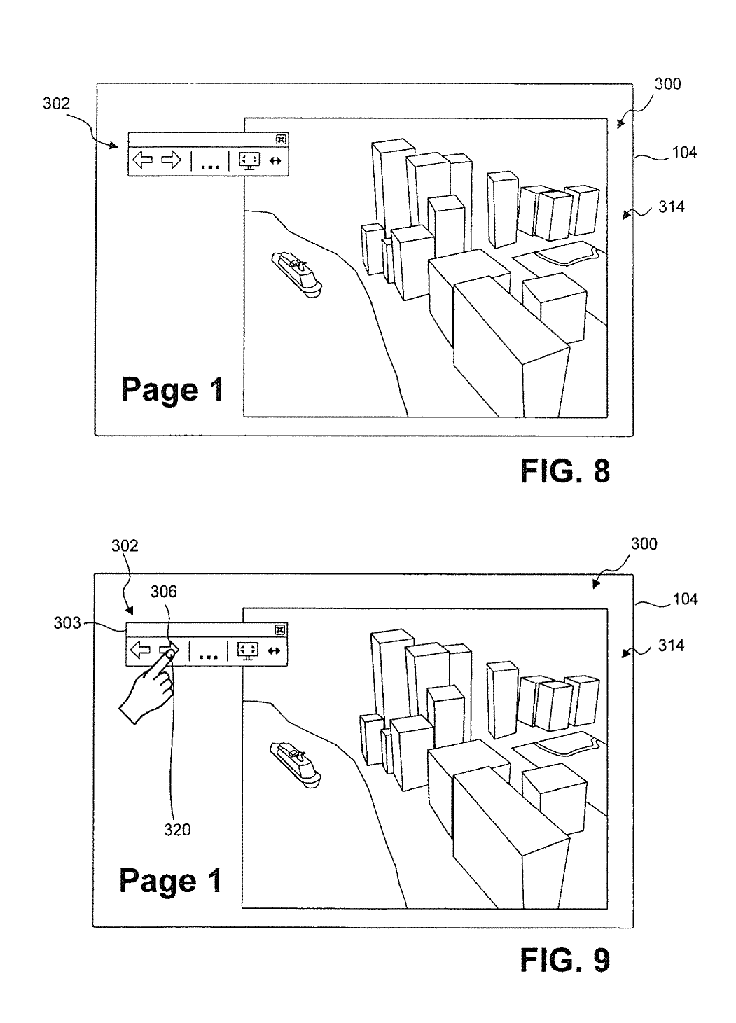

If no further input event occurs during the five (5) second period, the arrow 322 disappears from the GUI 300 displayed on the interactive surface 104, as shown in FIG. 8.

Turning now to FIG. 9, the GUI 300 is shown after processing an input event received from the IWB 102 triggered by a user's finger 320 touching the interactive surface 104 at a location in the active input area 302. The input event is processed according to method 240, as will now be described.

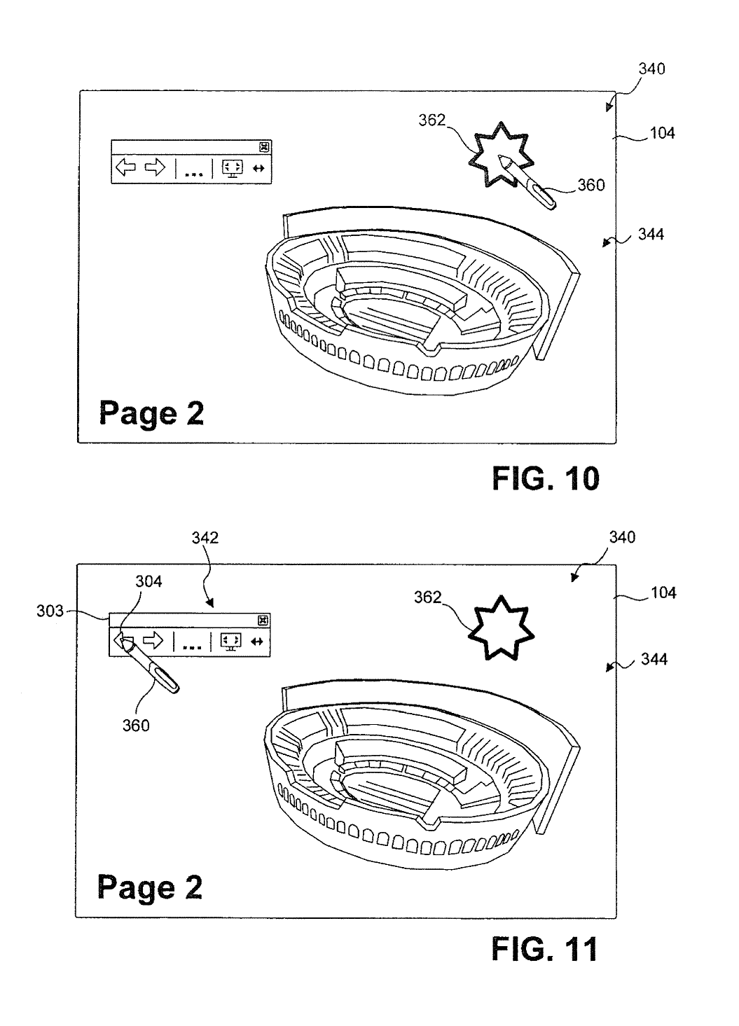

The input event is generated and sent to the input interface 204 when the finger 320 contacts the interactive surface 104 (step 242). The input interface 204 receives the input event (step 244), and determines that the input event is a touch input event (step 246). The input interface 204 determines that the active application is operating in the presentation mode (step 250) and that the pointer associated with the input event is in the cursor mode (step 252). As can be seen in FIG. 9, the input event is made on tool button 306 on toolbar 303 in the active control area 302 of the GUI 300 (step 256), and thus the input event is sent to the active application for processing. As a result, the function associated with the tool button 306 is executed, which causes the Microsoft® PowerPoint® application to forward the presentation to GUI 340 associated with the “Page 2” presentation slide (see FIG. 10). The method then ends (step 268).

Turning now to FIG. 10, GUI 340 is shown after processing an input event received from the IWB 102 triggered by a pen tool 360 touching the interactive surface 104 at a location in the inactive area 344. The input event is processed according to method 240, as will now be described.

The input event is generated and sent to the input interface 204 when the pen tool 360 contacts the interactive surface 104 (step 242). The input interface 204 receives the input event (step 244), and determines that the input event is a touch input event (step 246). The input interface 204 determines that the active application is operating in the presentation mode (step 250) and that the pointer associated with the input event is in the cursor mode (step 252). As can be seen in FIG. 10, the input event is made in the inactive area 344 of the GUI 340 (step 256), and the input interface 204 determines that the pointer associated with the input event is a pen tool 360 (step 260). Since the input event is made in the inactive area 344 of the GUI 340, and the pointer associated with the input event is a pen tool, the input interface 204 applies a permanent indicator to GUI 340 at the location of the input event (step 262), which in this embodiment is in the form of a star 362. Further, since the input event was made in the inactive area 344 of the GUI 340, the input event does not need to be sent to the active application (Microsoft® PowerPoint®), and thus the method ends (step 268).

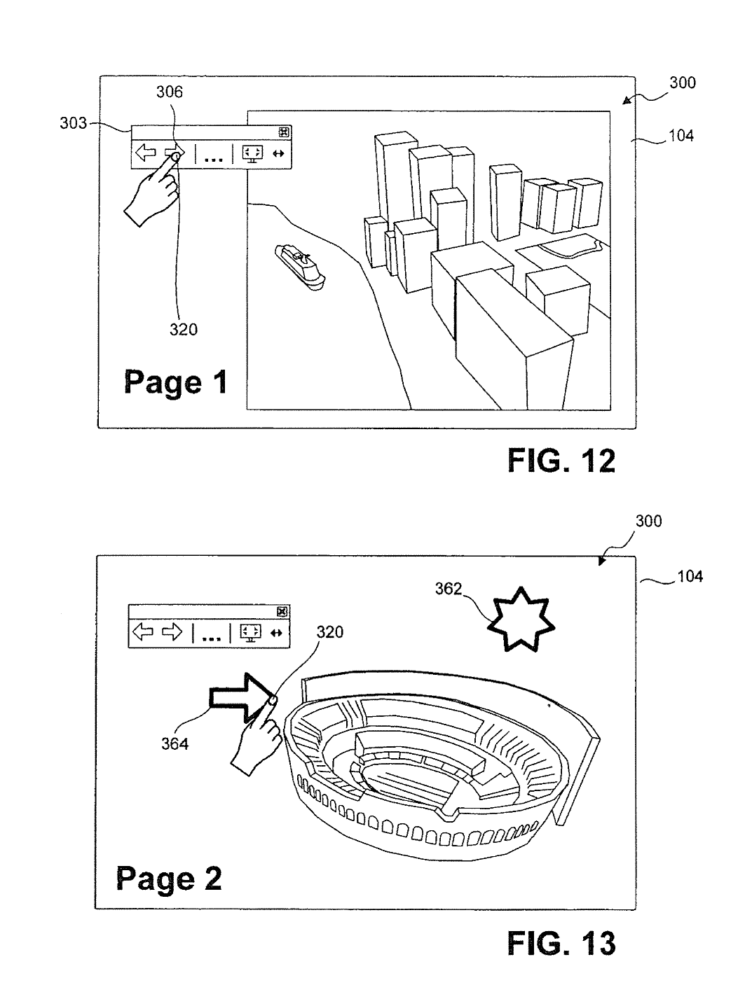

As mentioned previously, the permanent indicator appears on interactive surface 104 until deleted by a user. Thus, star 362 will appear on the interactive surface 104 regardless of whether or not a new input event has been received. For example, as shown in FIG. 11, the pen tool 360 is moved to a new location corresponding to the active area 342 of the GUI 340, creating a new input event while star 362 remains displayed within the inactive area 344. The new location of the pen tool 360 corresponds to tool button 304 within toolbar 303, and as a result the previous GUI 300 is displayed on the interactive surface 104, corresponding to the previous presentation slide (“Slide 1”), as shown in FIG. 12.

Turning to FIG. 12, the user again uses finger 320 to create an input event on tool button 306. Similar to that described above with reference to FIG. 9, the touch event occurs in the active control area, at the location of tool button 306. The function associated with the tool button 306 is executed, and thus the presentation is then forwarded to GUI 340 corresponding to the next presentation slide (“Slide 2”), as shown in FIG. 13. In FIG. 13, the permanent indicator in the form of star 362 remains displayed on the interactive surface 104. In addition to the permanent indicator 362, the user may use their finger 320 to contact the interactive surface 104, and as a result temporary indicator 364 is displayed on the interactive surface 104 at the location of the input event.

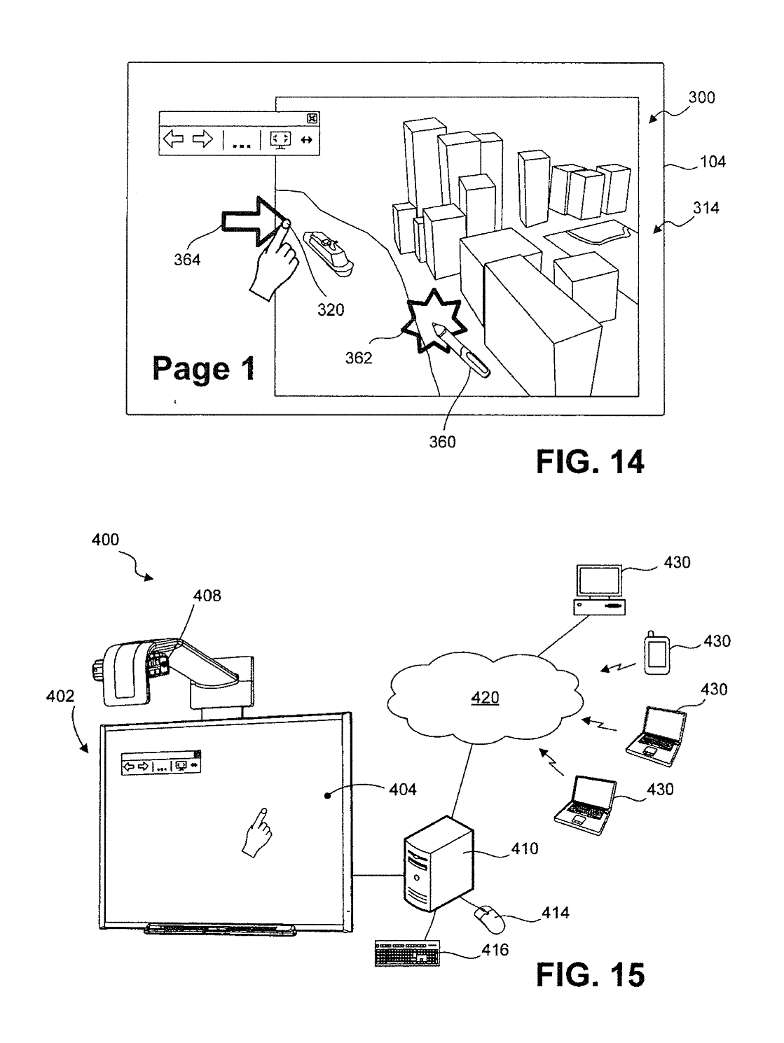

In this embodiment, the IWB 102 is a multi-touch interactive device capable of detecting multiple simultaneous pointer contacts on the interactive surface 104 and distinguishing different pointer types (e.g., pen tool, finger or eraser). As shown in FIG. 14, when a finger 320 and a pen tool 360 contact the interactive surface 104 at the same time in the inactive area 314, a temporary indicator 364 is displayed at the touch location of the finger 320, and a permanent indicator 362 is displayed at the touch location of the pen tool 360.

Turning now to FIG. 15, another embodiment of an interactive input system is shown and is generally identified by reference numeral 400. As can be seen, interactive input system 400 comprises an IWB 402, a projector 408, and a general purpose computing device 410, similar to those described above with reference to FIG. 1. Accordingly, the specifics of the IWB 402, projector 408, and general purpose computing device 410 will not be described further.

As can also be seen in FIG. 15, the general purpose computing device 410 is also connected to a network 420 such as for example a local area network (LAN), an intranet within an organization or business, a cellular network, or any other suitable wired or wireless network. One or more client devices 430 such as for example a personal computer, a laptop computer, a tablet computer, a computer server, a computerized kiosk, a personal digital assistant (PDA), a cell phone, a smart phone, etc., and combinations thereof are also connected to the network 420 via one or more suitable wired or wireless connections. As will be appreciated, the general purpose computing device 410, when connected to the network 420, also acts as a client device 430 and thus, in the following, will be referred to as such. The specifics of each client device 430 (including the general purpose computing device 410) will now be described. Generally, each client device 430 comprises software architecture, a display surface, and at least one input device such as for example a mouse or a keyboard.

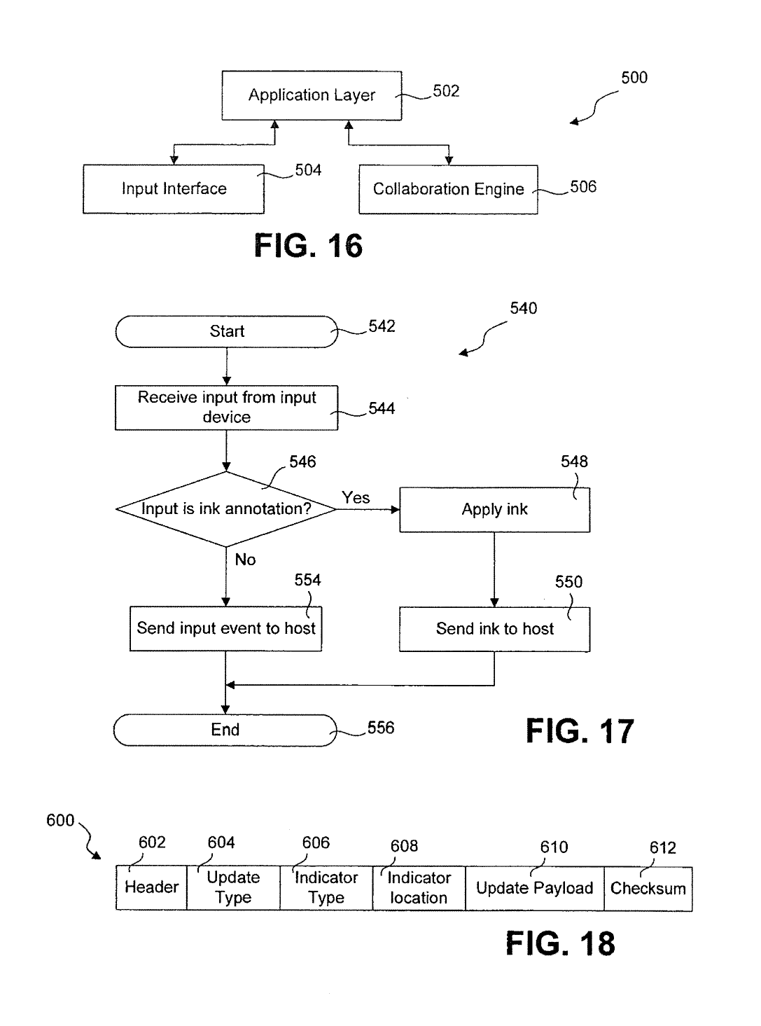

Turning now to FIG. 16, the software architecture of each client device 430 is shown and is generally identified by reference numeral 500. As can be seen, the software architecture 500 comprises an application layer 502 comprising one or more application programs, an input interface 504, and a collaboration engine 506. The application layer 502 and input interface 504 are similar to those described above with reference to FIG. 2, and accordingly the specifics will not be discussed further. The collaboration engine 506 is used to create or join a collaboration session (e.g., a conferencing session) for collaborating and sharing content with one or more other client devices 430 also connected to the collaboration session via the network 420. In this embodiment, the collaboration engine 506 is a SMART Bridgit™ software application offered by SMART Technologies ULC.

In the event one of the client devices 430 creates a Bridgit™ conferencing session, any other client device 430 connected to the network 420 may join the Bridgit™ session to share audio, video and data streams with all participant client devices 430. As will be appreciated, any one of client devices 430 can share its screen image for display on a display surface associated with each of the other client devices 430 during the conferencing session. Further, any one of the participant client devices 430 may inject input (a command or digital ink) via one or more input devices associated therewith such as for example a keyboard, mouse, IWB, touchpad, etc., to modify the shared screen image.

In the following, the client device that shares its screen image is referred to as the “host”. The client device that has injected an input event via one of its input devices to modify the shared screen image is referred to as the “annotator”, and the remaining client devices are referred to as the “viewers”.

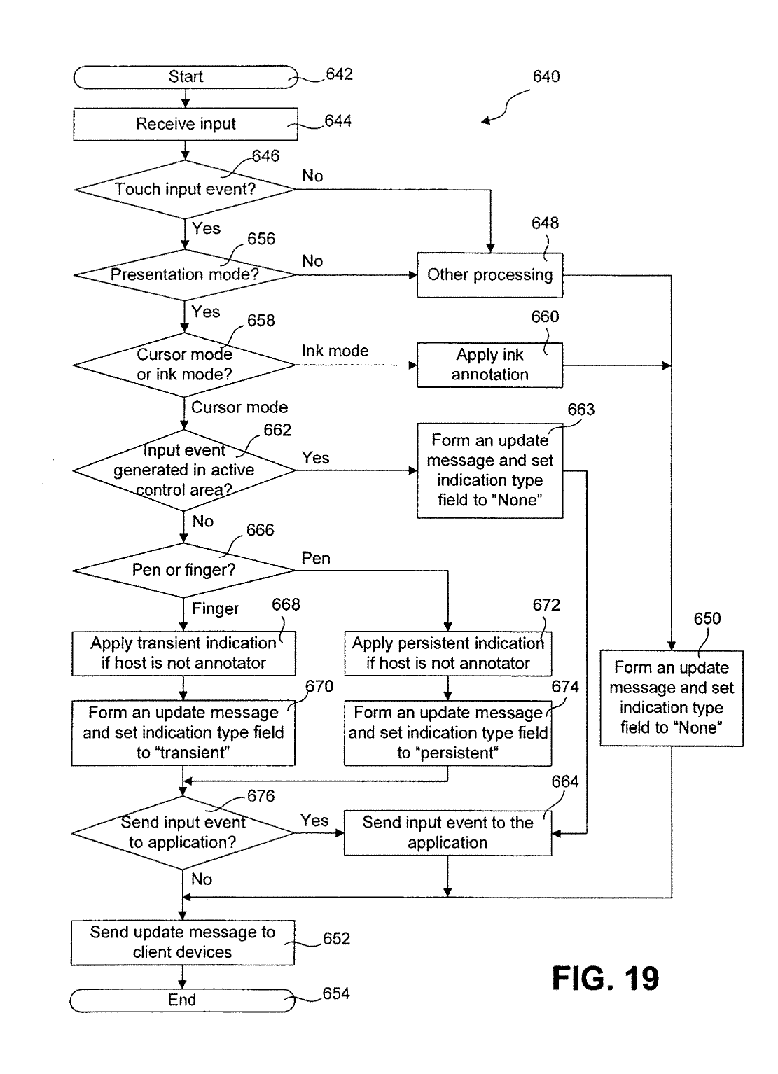

If the input event is generated by an input device associated with any one of client devices 430 that is not the host, that client device is designated as the annotator and the input event is processed according to method 540 described below with reference to FIG. 17. If the input event is generated by an input device associated with the host, the host is also designated as the annotator and the input event is processed according to method 640 described below with reference to FIG. 19. Regardless of whether or not the host is the annotator, the host processes the input event (received from the annotator if the host is not the annotator, or received from an input device if the host is the annotator) to update the shared screen image displayed on the display surfaces of the viewers by updating the shared screen image received from the host or by applying ink data received from the host.

Similar to interactive input system 100 described above, interactive input system 400 distinguishes input events based on pointer type and the object to which input events are applied such as for example an object associated with the active input area and an object associated with the inactive area. In this embodiment, the interactive input system 400 only displays temporary or permanent indicators on the display screen of the viewers, if the input event is not an ink annotation. The indicator(s) (temporary or permanent) are not displayed on the display screen of the annotator since it is assumed that any user participating in the collaboration session and viewing the shared screen image on the display surface of the annotator, is capable of viewing the input event live, that is, they are in the same room as the user creating the input event. For example, if the collaboration session is a meeting, and one of the participants (the annotator user) touches the interactive surface of the IWB 402, all meeting participants sitting in the same room as the annotator user, can simply see where the annotator user is pointing to on the interactive surface. Users participating in the collaboration session via the viewers (all client devices 430 that are not designated as the annotator), do not have a view of the annotator user, and thus an indicator is displayed on the display surfaces of the viewers allowing those users to determine where, on shared screen image, the annotator user is pointing.

Turning now to FIG. 17, the method 540 executed by the input interface 404 of the annotator for processing an input event received from an input device such as for example the IWB 402, mouse 414 or keyboard 416 is shown. As mentioned previously, method 540 is executed by the input interface 404 of the annotator, if the annotator is not the host. In the following, it is assumed that a collaboration session has already been established among participant client devices 430.

The method 540 begins at step 542, wherein each of the client devices 430 monitors its associated input devices, and becomes the annotator when an input event is received from one of its associated input devices. The annotator upon receiving an input event from one of its associated input devices (step 544), determines if the received input event is an ink annotation (step 546). As mentioned previously, an input event is determined to be an ink annotation if the input event is received from an IWB or mouse conditioned to operate in the ink mode. If the received input event represents an ink annotation, the annotator applies the ink annotation to the shared screen image (step 548), sends the ink annotation to the host (step 550), and the method ends (step 556). If the received input event does not represent an ink annotation, the annotator sends the input event to the host (step 554) and the method ends (step 556).

Once the host receives the input event, either received from the annotator at step 554 or generated by one of its associated input devices, the host processes the input event and updates the client devices 430 participating in the collaboration session such that the input event is applied to the shared screen image displayed on the display surface of all client devices 430 participating in the collaboration session.

The update is sent from the host to each of the participant client devices 430 in the form of an update message, the architecture of which is shown in FIG. 18. As can be seen, update message 600 comprises a plurality of fields. In this example, update message 600 comprises header field 602; update type field 604; indicator type field 606; indicator location field 608; update payload field 610; and checksum field 612. Header field 602 comprises header information such as for example the source address (the address of the host), the target address (multicast address), etc. The update type field 604 is an indication of the type of update payload field 610 and is a two-bit binary field that is set to: a value of zero (00) if no shared screen image change or ink annotation needs to be applied; a value of one (01) if the update payload field 610 comprises shared screen image changes, that is, the difference image of the current and previous shared screen image frames; or a value of two (10) if the update payload field 610 comprises an ink annotation. The indicator type field 606 is a two-bit binary field that is set to: a value of zero (00) if no indicator is required to be presented on the shared screen image; a value of one (01) if the temporary indicator is required to be presented on the shared screen image; a value of three (11) if the permanent indicator is required to be presented on the shared screen image. The indicator location field 608 comprises the location of the indicator to be applied, which as will be appreciated corresponds to the location of the input event. The update payload field 610 comprises the update data according to the update type field 604 described above. The checksum field 612 comprises the checksum of the update message 600 which is used by the client device 430 receiving the update message 600 to check if the received message comprises any errors.

Turning now to FIG. 19, the method 640 executed by the input interface 504 of the host for processing an input event received from the annotator (when the host is not the annotator) or from an input device associated with the host (when the host is the annotator) is shown. It is assumed that an input event is made on the GUI of the active application in the shared screen image, and that before the update message is sent to other client devices 430, the update type field 604 and update payload field 610 are updated to accommodate any shared screen image change or ink annotation.

The method begins when an input event is received by the input interface 504 from either the annotator, or from an input device associated with the host (step 644). The input interface 504 determines if the input event is a touch input event (step 646).

If the input event is not a touch input event, the input event is sent to a respective program (e.g., an application in the application layer 502 or the input interface 504) for processing (step 648). An update message is then created wherein the indicator type field 606 is set to a value of zero (00) indicating that no indicator is required to be presented on the shared screen image (step 650). The update message is sent to the participant client devices 430 (step 652), and the method ends (step 654).

If the input event is a touch input event, the input interface 504 determines if the active application is operating in the presentation mode (step 656). As mentioned previously, the Microsoft® PowerPoint® application is in the presentation mode if the add-in program thereto detects that a SlideShowBegin event has occurred.

If the active application is not operating in the presentation mode, the input event is sent to a respective program for processing (step 648). An update message is then created wherein the indicator type field 606 is set to a value of zero (00) indicating that no indicator is required to be presented on the shared screen image (step 650), the update message is sent to the participant client devices 430 (step 652), and the method ends (step 654).

If the active application is operating in the presentation mode, the input interface 504 determines if the pointer associated with the received input event is in the ink mode or a cursor mode (step 658). If the pointer associated with the received input event is in the ink mode, the input event is recorded as writing or drawing by a respective program (step 660). An update message is then created wherein the indicator type field 606 is set to a value of zero (00) indicating that no indicator is required to be presented on the shared screen image (step 650), the update message is sent to the participant client devices 430 (step 652), and the method ends (step 654).

If the pointer associated with the received input event is in the cursor mode, the input interface 504 determines if the input event was made in the active control area of the active GUI (step 662). If the input event was made in the active control area of the active GUI, an update message is created wherein the indicator type field 606 is set to a value of zero (00) indicating that no indicator is required to be presented on the shared screen image (step 663). The input event is sent to the active application of the application layer 502 for processing (step 664). If the input event prompts an update to the screen image, the updated payload field 610 of the update message is then filled with a difference image (the difference between the current screen image and the previous screen image). The update message is then sent to the participant client devices 430 (step 652), and the method ends (step 654).

If the input event was not made in the active control area of the active application window, it is determined that the input event is made in the inactive area (assuming that the input event is made in the GUI of the active application) and the input interface 504 determines if the pointer associated with the input event is a pen or a finger (step 666). If the pointer associated with the input event is a finger, the input interface 504 applies a temporary indicator to the active GUI at the location of the input event, if the host is not the annotator (step 668). If the host is the annotator, no temporary indicator is applied to the active GUI. An update message is then created wherein the indicator type field 606 is set to one (01), indicating that a temporary indicator is to be applied (step 670), and wherein the indicator location field 608 is set to the location that the input event is mapped to on the active GUI.

If the pointer associated with the input event is a pen, the input interface 504 applies a permanent indicator to the active GUI at the location of the input event, if the host is not the annotator (step 672). If the host is the annotator, no permanent indicator is applied to the active GUI. An update message is then created wherein the indicator type field 606 is set to three (11) indicating that a permanent indicator is to be applied (step 674), and wherein the indicator location field 608 is set to the location that the input event is mapped to on the active GUI.

The input interface 504 of the host then determines if the input event needs to be sent to the active application, based on defined rules (step 676). If the input event is not to be sent to the active application, the update message is sent to the participant client devices 430 (step 652), and the method ends (step 654). If the input event is to be sent to the active application, the input event is sent to the active application of the application layer 502 for processing (step 664). The update message 600 is sent to participant client devices 430 (step 652), and the method ends (step 654).

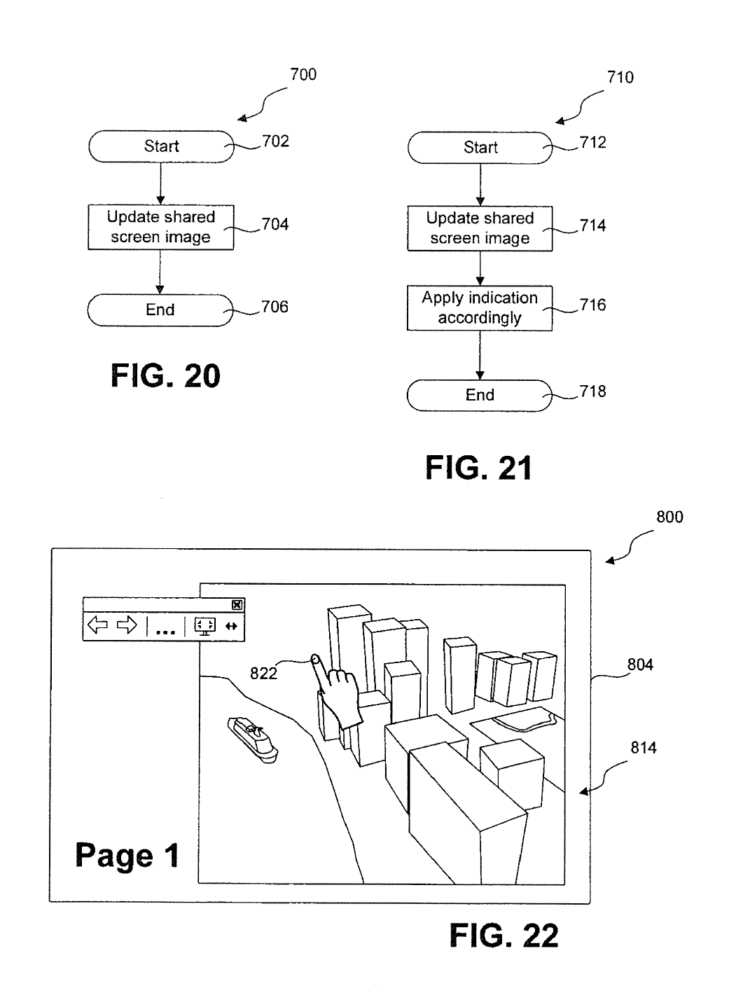

Once the update message is received by the annotator from the host (wherein the host is not the annotator), the shared screen image is updated according to method 700, as will now be described with reference to FIG. 20. The method 700 begins when the annotator receives the update message (step 702). The annotator updates the shared screen image stored in its memory using data received in the update message, in particular from the update type field 604 and update payload field 610 (step 704). As mentioned previously, no indicator is displayed on the display surface of the annotator, and thus the indicator type field 606 and the indicator location field 608 are ignored. The method then ends (step 706).

Once the update message is received by each viewer from the host, the shared screen image displayed on the display surface of each viewer is updated according to method 710, as will be described with reference to FIG. 21. The method 710 begins when the viewer receives the update message from the host (step 712). The viewer updates the shared screen image stored in its memory using data received in the update message, in particular from the update type field 604 and update payload field 610 (step 714). For example, if the update type field 604 has a value of zero (00), the viewer does not need to update the shared screen image; if the update type field 604 has a value of one (01), the viewer uses the data in update payload field 610 to update the shared screen image; and if the update type field 604 has a value of two (10), the viewer uses the data in update payload field 610 to draw the ink annotation. The viewer then checks the indicator type field 606 of the received update message, and applies: no indicator if the value of the indicator type field 606 is zero (00); a temporary indicator if the value of the indicator type field 606 is one (01); or a permanent indicator if the value of the indicator type field 606 is three (11) (step 716). The method then ends (step 718).

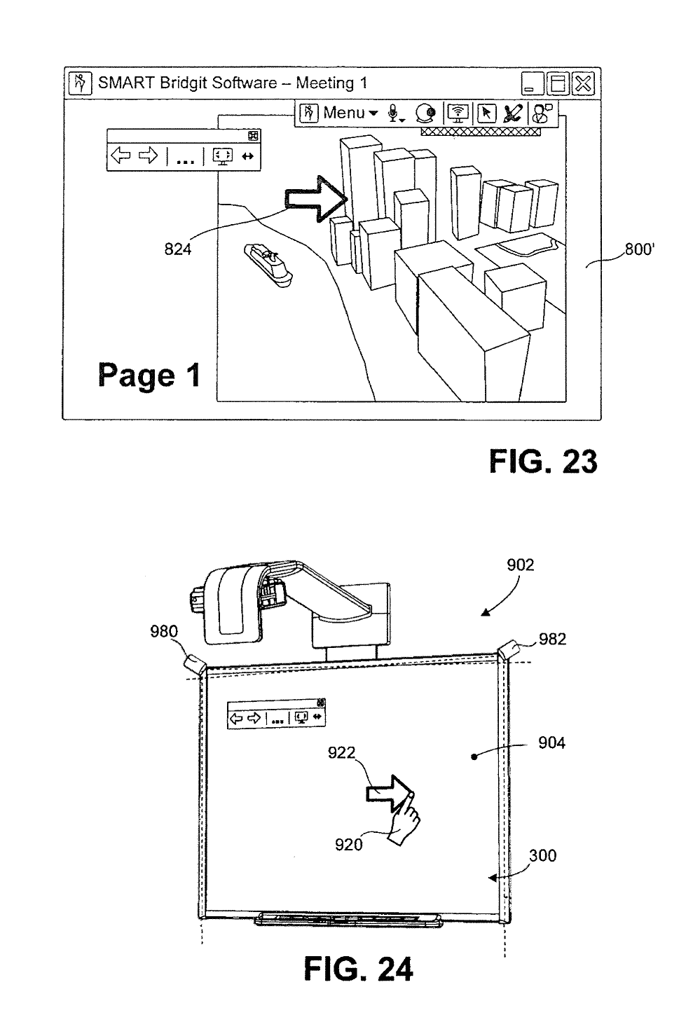

Examples will now be described in the event a user contacts the interactive surface 404 of the IWB 402, creating an input event with reference to FIGS. 22 and 23. Displayed on the interactive surface 404 is GUI 800, which as will be appreciated, is similar to GUI 300 described above. Accordingly, the specifics of GUI 800 will not be described further.

FIGS. 22 and 23 illustrate GUI 800 after processing an input event generated in response to a user's finger 822 in the inactive area 814. GUI 800 is output by the general purpose computing device 410, which in this embodiment is the host of the collaboration session, to the projector (not shown) where GUI 800 is projected onto the interactive surface 404 of IWB 402. GUI 800 is also displayed on the display surface of all participant client devices 430 connected to the collaboration session via the network. As will be appreciated, since the input event is received on the interactive surface 404 of the host, the host is also the annotator. The input event associated with the user's finger 822 is processed according to method 640, as will now be described.

The input event caused by the user's finger 822 is received by the input interface 504 of the host (step 644). The input interface 504 determines that the input event is a touch input event (step 646). The input interface 504 determines that the active application is operating in the presentation mode (step 656) and that the pointer associated with the touch input event is in the cursor mode (step 658). As can be seen in FIG. 22, the input event is generated in response to the user's finger being in the inactive area 814 of the GUI 800 (step 662), and the input interface 504 determines that the pointer associated with the input event is a finger (step 666). Since the annotator is the host (step 668) no temporary indicator is applied to GUI 800. The indicator type field 606 of the update message is set to one (01) indicating that a temporary indicator is to be applied (step 670). The input interface 504 of the host then determines that the input event is not to be sent to the application layer (step 676), based on defined rules, that is, the input event does not trigger a change in a slide or any other event associated with the Microsoft® PowerPoint® application. The update message is then sent to the other client devices 430 (step 652), and the method ends (step 654).

Once the update message is received by each viewer from the host, the shared screen image on the display surface of each viewer is updated according to method 710, as will now be described. The method 710 begins when the viewer receives the update message from the host (step 712). In this example, the update type field 604 has a value of zero (00) and thus the viewer does not need to update the shared screen image (step 714).

The viewer checks the indicator type field 606 of the received update message, and since the indicator type field is set to one (01), a temporary indictor 824 is applied to GUI 800′ at the location of the input event, as provided in the indicator location field 608 of the received update message (step 716), as shown in FIG. 23. The method then ends (step 718). It should be noted that FIG. 23 shows the shared screen image of the host (GUI 800′), as displayed on the display surface of one of the client devices 430. As will be appreciated, a temporary indicator is applied to the display surface of all client devices 430 that are not the annotator, and thus the input event may be viewed by each of the participants in the collaboration session.

In another embodiment, the interactive input system comprises an IWB which is able to detect pointers brought into proximity with the interactive surface without necessarily contacting the interactive surface. For example, when a pointer is brought into proximity with the interactive surface (but does not contact the interactive surface), the pointer is detected and if the pointer remains in the same position (within a defined threshold) for a threshold period of time, such as for example one (1) second, a pointing event is generated. A temporary or permanent indicator (depending on the type of pointer) is applied to the GUI of the active application at the location of the pointing gesture (after mapping to the GUI) regardless of whether the location of the pointing gesture is in the active control area or the inactive area. However, as described previously, if a touch input event occurs on the interactive surface of the IWB, an indicator is applied to the GUI of the active application only when the location of the touch input event is in the inactive area.

In the following, alternative embodiments of interactive whiteboards are described that may be used in accordance with the interactive input systems described above. For ease of understanding, the following embodiments will be described with reference to the interactive input system described above with reference to FIG. 1; however, as those skilled in the art will appreciate, the following embodiments may alternatively be employed in the interactive input system described with reference to FIG. 14.

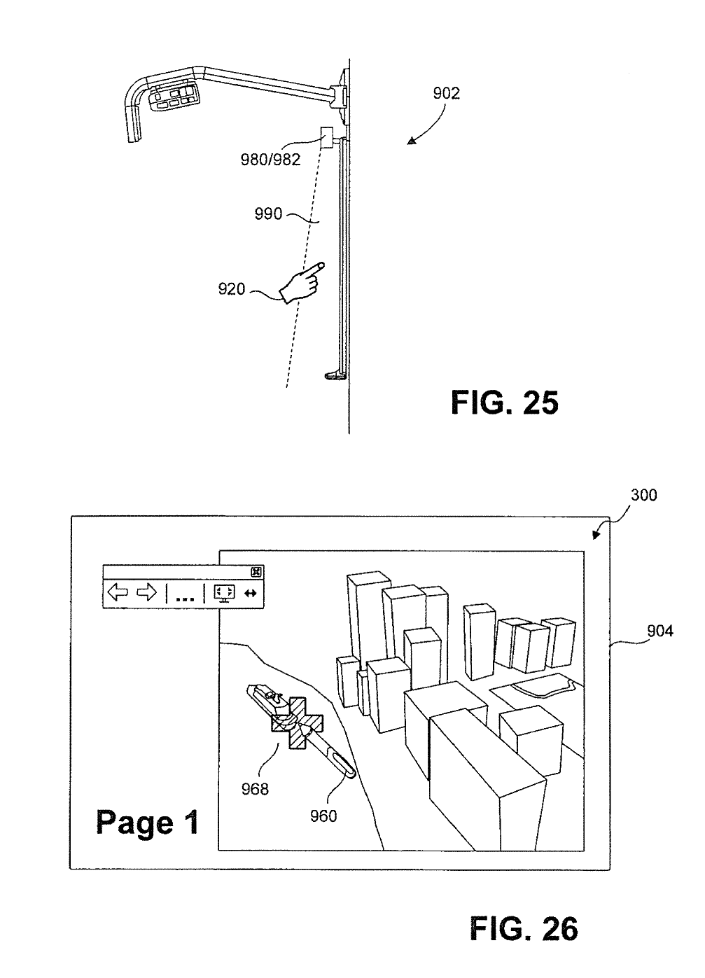

Turning now to FIGS. 24 and 25, another embodiment of an IWB is shown and is generally identified by reference numeral 902. IWB 902 is similar to IWB 102 described above with the addition of two imaging devices 980 and 982, each positioned adjacent to a respective top corner of the interactive surface 904. Of course, those of skill in the art will appreciate that the imaging devices may be positioned at alternative locations relative to the interactive surface 904. As can be seen, the imaging devices 980 and 982 are positioned such that their fields of view look generally across the interactive surface 904 allowing gestures made in proximity with the interactive surface 904 to be determined. Each imaging device 980 and 982 has a 90° field of view to monitor a three-dimensional (3D) interactive space 990 in front of the interactive surface 904. The imaging devices 980 and 982 are conditioned to capture images of the 3D interactive space 990 in front of the interactive surface 904. Captured images are transmitted from the imaging devices 980 and 982 to the general purpose computing device 110. The general purpose computing device 110 processes the captured images to detect a pointer (e.g., pen tool, a user's finger, a user's hand) brought into the 3D interactive space 990 and calculates the location of the pointer using triangulation. Input events are then generated based on the gesture performed by the detected pointer. For example, a pointing gesture is detected if a pointer is detected at the same location (up to a defined distance threshold) for a defined threshold time. The pointer location is mapped to a position on the interactive surface 904. If the pointer is a user's finger, a temporary indicator is applied to the active GUI at the location of the pointing gesture. If the pointer is a pen tool, a permanent indicator is applied to the active GUI at the location of the pointing gesture.

As shown in FIG. 24, a user's finger 920 is brought into the 3D interactive space 990 at a location corresponding to the inactive area of GUI 300 displayed on the interactive surface 904, and thus a temporary indicator 922 is presented.

The general purpose computing device 110 connected to IWB 902 may also process the captured images to calculate the size of the pointer brought into the 3D interactive space 990, and based on the size of the pointer, may adjust the size of the indicator displayed on the interactive surface 904.

FIG. 26 shows a pointer in the form of a pen tool 960 brought within the 3D interactive space 990, resulting in a pointing gesture being detected. The pointer location (i.e., the location of the pointing gesture) is mapped to a position on the interactive surface 904. Since the pointer is a pen tool, a permanent indicator is displayed on the interactive surface 904. The size of the pen tool 960 is also calculated, and compared to a defined threshold. In this example, based on the comparison, the size of the pen tool is determined to be small, and thus a small permanent indicator 968 is displayed on the interactive surface 904 at the location of the input event.

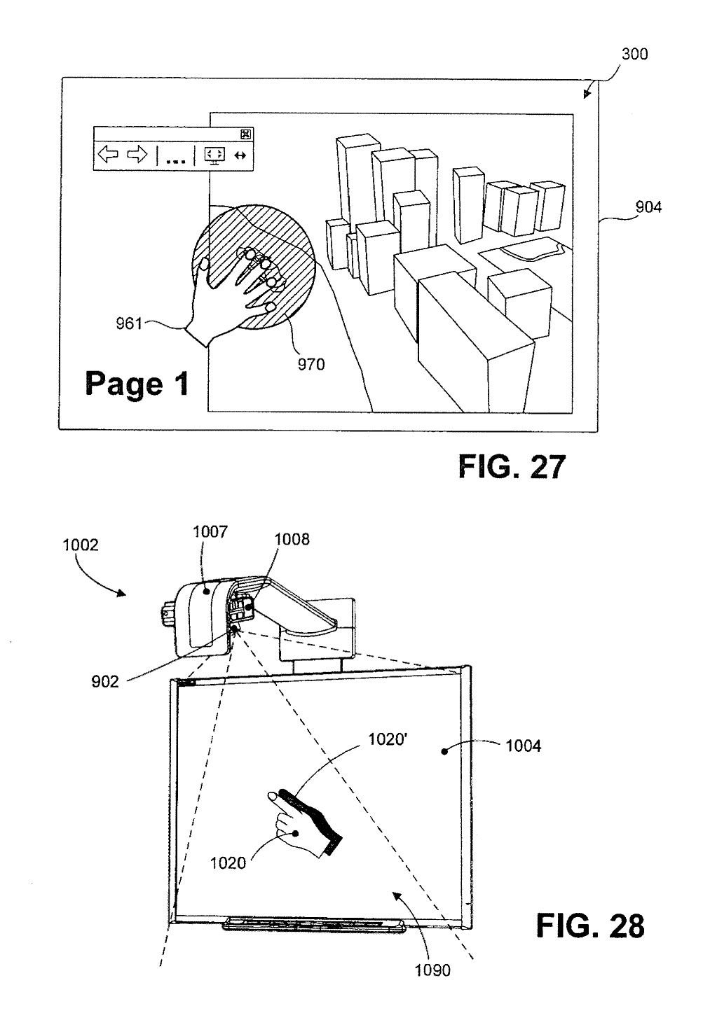

FIG. 27 shows a pointer in the form of a user's hand 961 brought within the 3D interactive space 990, resulting in a pointing gesture being detected. The pointer location (i.e., the location of the pointing gesture) is mapped to a position on the interactive surface 904. Since the pointer is a user's hand, a temporary indicator is displayed on the interactive surface 904. The size of the user's hand 961 is also calculated, and compared to a defined threshold. In this example, based on the comparison, the size of the user's hand 961 is determined to be large, and thus a large temporary indicator 970 is displayed on the interactive surface 904 at the mapped location of the pointing gesture.

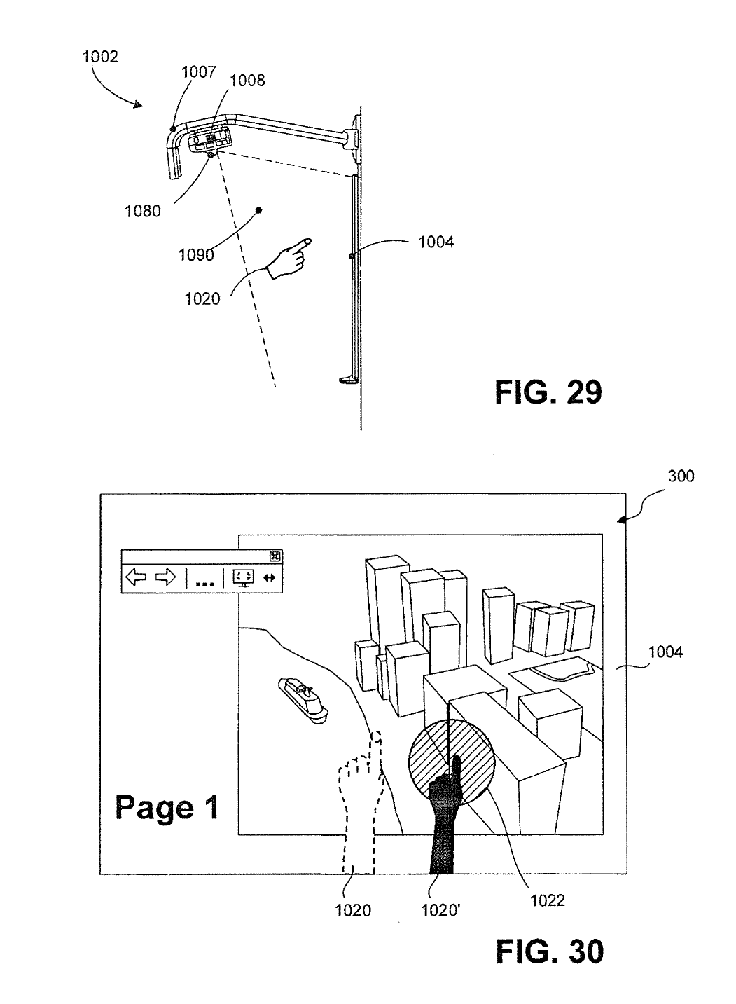

Turning now to FIGS. 28 and 29, another embodiment of an IWB is shown and is generally identified by reference numeral 1002. IWB 1002 is similar to IWB 102 described above, with the addition of an imaging device 1080 positioned on a projector boom assembly 1007 at a distance from the interactive surface 1004. The imaging device 1080 is positioned to have a field of view looking towards the interactive surface 1004. The imaging device 1080 captures images of a 3D interactive space 1090 disposed in front of the interactive surface 1004 including the interactive surface 1004. The 3D interactive space 1090 defines a volume within which a user may perform a variety of gestures. When a gesture is performed by a user's hand 1020 at a location intermediate the projector 1008 and the interactive surface 1004, the hand 1020 occludes light projected by the projector 1008 and as a result, a shadow 1020′ is cast onto the interactive surface 1004. The shadow 1020′ cast onto the interactive surface 1004 appears in the images captured by the imaging device 1080. The images captured by the imaging device 1080 are sent to the general purpose computing device 110 for processing. The general purpose computing device 110 processes the captured images to determine the position of the shadow 1020′ on the interactive surface 1004, and to determine if the hand 1020 is directly in contact with the interactive surface 1004 (in which case the image of the hand 1020 overlaps with the image of the shadow 1020′ in captured images), is near the interactive surface 1004 (in which case the image of the hand 1020 partially overlaps with the image of the shadow 1020′ in captured images), or is distant from the interactive surface 1004 (in which case the image of the hand 1020 is not present in captured images or the image of the hand 1020 does not overlap with the image of the shadow 1020′ in captured images). Further specifics regarding the detection of the locations of the hand 1020 and the shadow 1020′ are described in U.S. patent application Ser. No. 13/077,613 entitled “Interactive Input System and Method” to Tse, et al., filed on Mar. 31, 2011, assigned to SMART Technologies ULC, the disclosure of which is incorporated herein by reference in its entirety.

In the event a temporary or permanent indicator is to be presented on the interactive surface 1004, the general purpose computing device adjusts the size of the indicator presented on the interactive surface 1004 based on the proximity of the hand 1020 to the interactive surface 1004. For example, a large indicator is presented on the interactive surface 1004 when the hand 1020 is determined to be distant from the interactive surface 1004, a medium size indicator is presented on the interactive surface 1004 when the hand 1020 is determined to be near the interactive surface 1004, and a small indicator is presented in the event the hand 1020 is determined to be in contact with the interactive surface 1004. The indicator is presented on the interactive surface 1004 at the position of the tip of shadow 1020′.

FIG. 30 shows a user's hand 1020 brought into proximity with the 3D interactive space 1090, resulting in a pointing gesture being detected. The pointer location is mapped to a position on the interactive surface 1004. Since the pointer is a user's hand, a temporary indicator is displayed on the interactive surface 1004. As can be seen, since the user's hand 1020 does not overlap with the shadow 1020′ of the user's hand cast onto the interactive surface 1004, it is determined that the user's hand 1020 is distant from the interactive surface 1004. Based on this determination, a large temporary indicator 1022 is displayed on the interactive surface 1004 at the mapped location of the pointing gesture (the tip of the shadow 1020′).

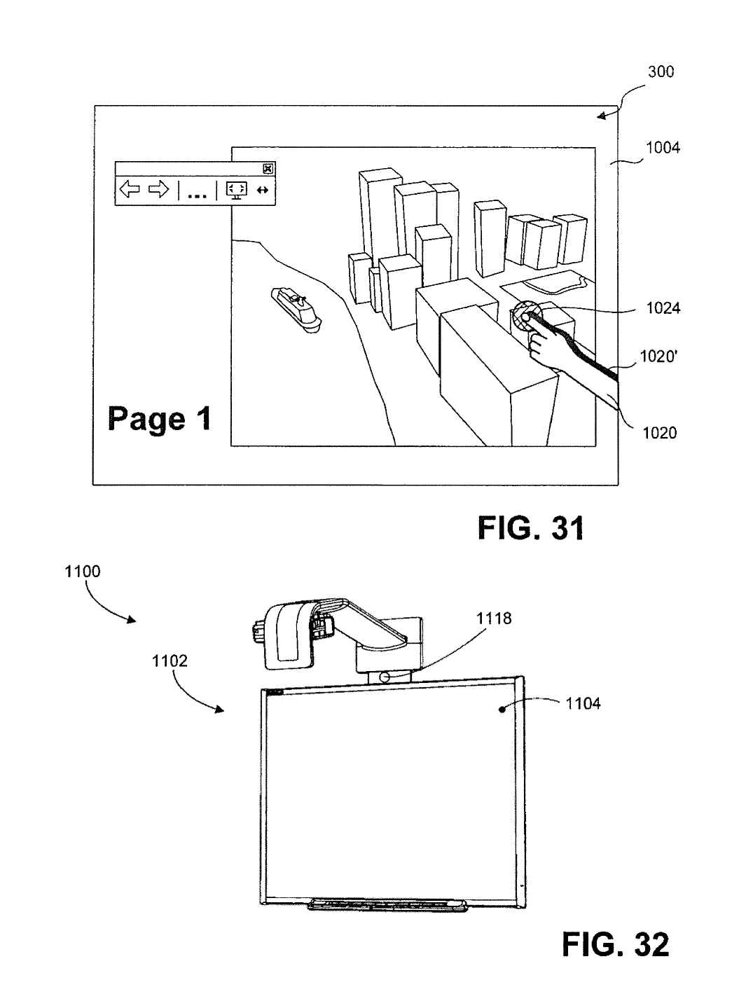

FIG. 31 shows a pointer in the form of a user's hand 1020 brought into proximity with the 3D interactive space 1090, resulting in a pointing gesture being detected. The pointer location is mapped to a position on the interactive surface 1004. Since the pointer is a user's hand, a temporary indicator is displayed on the interactive surface 1004. As can be seen, since the user's hand 1020 partially overlaps with the shadow 1020′ of the user's hand cast onto the interactive surface 1004, it is determined that the user's hand 1020 is close to the interactive surface 1004. Based on this determination, a medium sized temporary indicator 1024 is displayed on the interactive surface 1004 at the mapped location of the pointing gesture (the tip of the shadow 1020′).

Turning now to FIG. 32, another embodiment of an IWB is shown and is generally identified by reference numeral 1100. IWB 1102 is similar to IWB 102 described above, with the addition of a range imaging device 1118 positioned above the interactive surface 1104 and looking generally outwardly therefrom. The range imaging device 1118 is an imaging device, such as for example a stereoscopic camera, a time-of-flight camera, etc., capable of measuring the depth of an object brought within its field of view. As will be appreciated, the depth of the object refers to the distance between the object and a defined reference point.

The range imaging device 1118 captures images of a 3D interactive space in front of the IWB 1102, and communicates the captured images to the general purpose computing device 110. The general purpose computing device 110 processes the captured images to detect the presence of one or more user's positioned within the 3D interactive space, to determine if one or more pointing gestures are being performed and if so to determine the 3D positions of a number of reference points on the user such as for example the position of the user's head, eyes, hands and elbows according to a method such as that described in U.S. Pat. No. 7,686,460 entitled “Method and Apparatus for Inhibiting a Subject's Eyes from Being Exposed to Projected Light” to Holmgren, et al., issued on Mar. 30, 2010 or in U.S. Patent Application Publication No. 2011/0052006 entitled “Extraction of Skeletons from 3D Maps” to Gurman et al., filed on Nov. 8, 2010.

IWB 1102 monitors the 3D interactive space to detect one or more users and determines each user's gesture(s). In the event a pointing gesture has been performed by a user, the general purpose computing device 110 calculates the position on the interactive surface 1104 pointed to by the user.

Similar to interactive input system 100 described above, a temporary indicator is displayed on the interactive surface 1104 based on input events performed by a user. Input events created from the IWB 1102, keyboard or mouse (not shown) are processed according to method 240 described previously. The use of range imaging device 1118 provides an additional input device, which permits a user's gestures made within the 3D interactive space to be recorded as input events and processed according to a method, as will now be described.

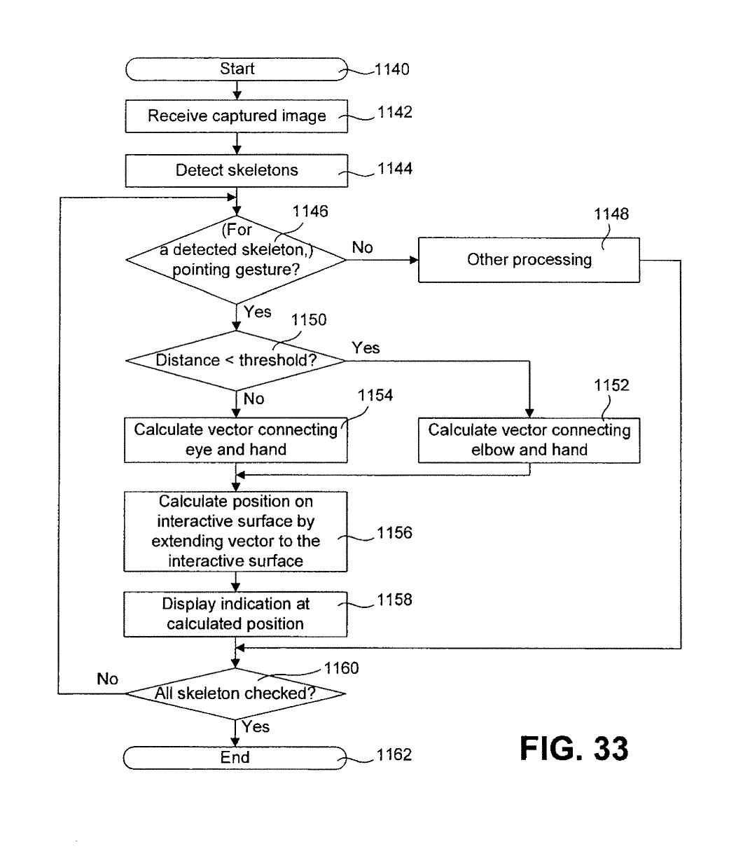

Turning now to FIG. 33, a method for processing an input event detected by processing images captured by the range imaging device 1118 is shown and is generally identified by reference numeral 1140. Method 1140 begins in the event a captured image is received from the range imaging device 1118 (step 1142).

The captured image is processed by the general purpose computing device 110 to determine the presence of one or more skeleton's indicating the presence of one or more user's in the 3D interactive space (step 1144). In the event that no skeleton is detected, the method ends (step 1162). In the event that at least one skeleton is detected, the image is further processed to determine if a pointing gesture has been performed by a first detected skeleton (step 1146).

If no pointing gesture is detected, the method continues to step 1148 for further processing such as for example to detect and process other types of gestures, and then continues to determine if all detected skeletons have been analyzed to determine if there has been a pointing gesture (step 1160).

If a pointer gesture has been detected, the image is further processed to calculate the distance between the skeleton and the IWB 1102, and the calculated distance is compared to a defined threshold, such as for example two (2) meters (step 1150).

If the distance between the user and the IWB 1042 is smaller than the defined threshold, the image is further processed to calculate a 3D vector connecting the user's elbow and hand, or, if the user's fingers can be accurately detected in the captured image, the image is further processed to calculate a 3D vector connecting the user's elbow and the finger used to point (step 1152).

If the distance between the user and IWB 1102 is greater than the defined threshold, the image is further processed to calculate a 3D vector connecting the user's eye and hand (step 1154). In this embodiment, the position of the user's eye is estimated by determining the size and position of the head, and then calculating the eye position horizontally as the center of the head and the eye position vertically as one third (⅓) the length of the head.

Once the 3D vector is calculated at step 1152 or step 1154, the 3D vector is extended in a straight line to the interactive surface 1104 to approximate the intended position of the pointing gesture on the interactive surface 1104 (step 1156). The calculated location is thus recorded as the location of the pointing gesture, and an indication is displayed on the interactive surface 1104 at the calculated location (step 1158). Similar to previous embodiments, the size and/or type of the indicator is dependent on the distance between the detected user and the IWB 1102 (as determined at step 1150). In the event the distance between the user and the IWB 1102 is less than the defined threshold, a small indicator is displayed. In the event the distance between the user and the IWB 1102 is greater than the defined threshold, a large indicator is displayed.

A check is then performed (step 1160) to determine if all detected skeletons have been analyzed (step 1160). In the event more than one skeleton is detected at step 1044, and not all of the detected skeletons have been analyzed to determine a pointing gesture, the method returns to step 1146 to process the next detected skeleton. In the event all detected skeletons have been analyzed, the method ends (step 1162).

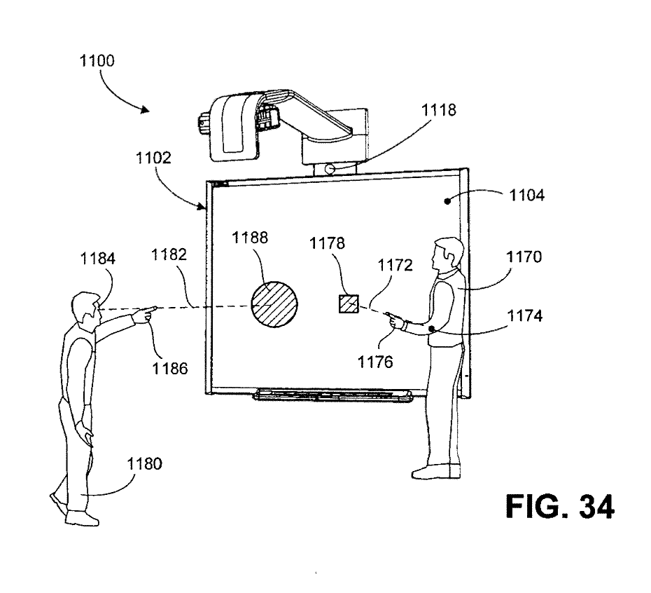

FIG. 34 illustrates an example of IWB 1102 in the event two pointing gestures are performed within the 3D interactive space. As can be seen, two different indicators are displayed on the interactive surface 1104 based on the distance of each respective user from the IWB 1102. The indicators are presented on the IWB 1102 according to method 1140, as will now be described.

Range imaging device 1118 captures an image and sends it to the general purpose computing device 110 for processing (step 1142). The captured image is processed, and two skeletons corresponding to users 1170 and 1180 are detected (step 1144). The image is further processed, and it is determined that the skeleton corresponding to user 1170 indicates a pointing gesture (step 1146). The distance between the skeleton corresponding to user 1170 and the IWB 1102 is calculated, which in this example is 0.8 meters and is compared to the defined threshold, which in this example is two (2) meters (step 1150). Since the distance between the user 1170 and the IWB 1002 is less than the threshold, a 3D vector 1172 is calculated connecting the user's elbow 1174 and hand 1176 (step 1152). The 3D vector 1172 is extended in a straight line to the interactive surface 1104 as shown, and the approximate intended location of the pointing gesture is calculated (step 1156). The calculated location is recorded as the location of the pointing gesture, and an indicator 1178 is displayed on the interactive surface 1104 at the calculated location (step 1158).

A check is then performed (step 1160) to determine if all detected skeletons have been analyzed. Since the skeleton corresponding to user 1180 has not been analyzed, the method returns to step 1146.

The image is further processed, and it is determined that the skeleton corresponding to user 1180 also indicates a pointing gesture (step 1146). The distance between the skeleton corresponding to user 1180 and the IWB 1042 is calculated to be 2.5 meters and is compared to the defined threshold of two (2) meters (step 1150). Since the distance between the user 1180 and the IWB 1042 is greater than the threshold, a 3D vector 1182 is calculated connecting the user's eyes 1184 and hand 1186 (step 1154). The 3D vector 1182 is extended in a straight line to the interactive surface 1104 as shown, and the approximate intended location of the pointing gesture on the interactive surface is calculated (step 1156). The calculated location is recorded as the location of the pointing gesture, and an indicator 1188 is displayed on the interactive surface 1104 at the calculated location (step 1158).

Comparing indicators 1178 and 1188, it can be seen that the indications are different sizes and shapes due to the fact that user 1170 and user 1180 are positioned near and distant from the IWB 1102, respectively, as determined by comparing their distance from the IWB 1102 to the defined threshold of two (2) meters.

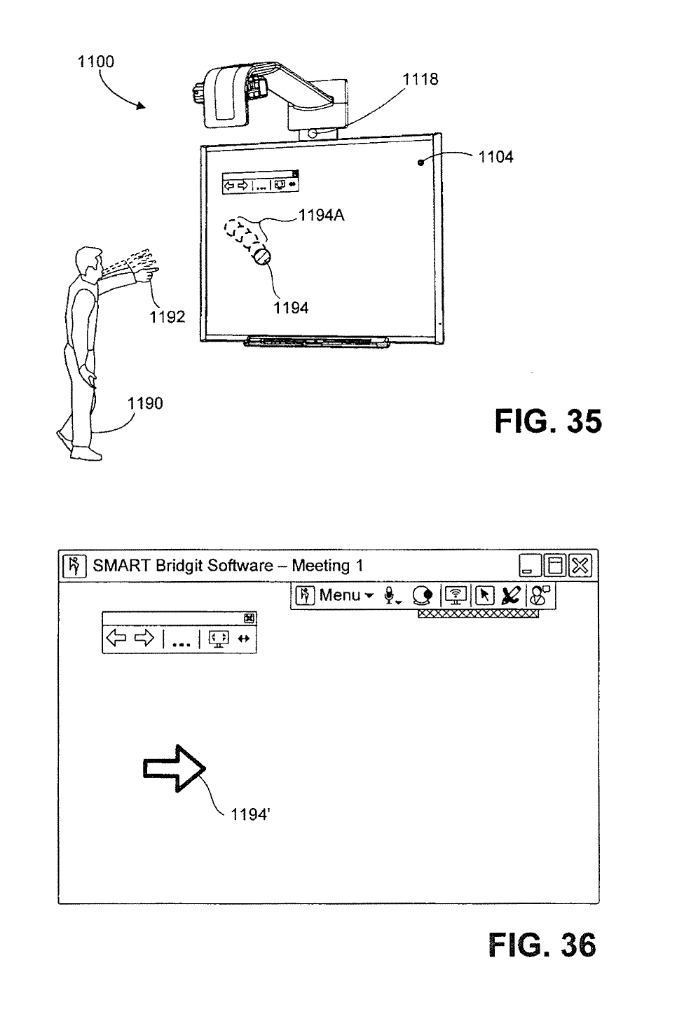

In another embodiment, IWB 1102 is connected to a network and partakes in a collaboration session with multiple client devices, similar to that described above with reference to FIG. 14. For example, as shown in FIG. 35, IWB 1102 is the host sharing its screen image with all other client devices (not shown) connected to the collaboration session. In the event that a direct touch input event is received or a gesture is performed within the 3D interactive space, the IWB 1102 becomes the annotator. In this embodiment, in the event a direct touch input event or 3D gesture is received, the indicator displayed on the interactive surface 1104 is different than the indicator displayed on the display surfaces of the other client devices.

As shown in FIG. 35, a user 1190 positioned within the 3D interactive space performs a pointing gesture 1192. The pointing gesture is identified and processed according to method 1140 described above. As can be seen, an indicator 1194 in the form of a semi-transparent highlight circle is displayed on the interactive surface 1104 corresponding to the approximate intended location of the pointing gesture 1192.

The host provides a time delay to allow the user to adjust the position of the indicator 1194 to a different location on the interactive surface 1104 before the information of the indicator is sent to other participant client devices. The movement of the pointing gesture is indicated in FIG. 35 by previous indicators 1194A.

After the expiry of the time delay, the host sends the information including the pointer location and indicator type (temporary or permanent) to the participant client devices.

FIG. 36 illustrates an exemplary display surface associated with one of the client devices connected to the collaboration session hosted by the IWB 1104 of FIG. 35. As can be seen, an indicator 1194′ in the form of an arrow is displayed on the display surface, corresponding to the location of the pointing gesture made by user 1190 in FIG. 35. Indicator 1194′ is used to indicate to the viewers where, on the display surface, the user associated with the annotator is pointing.

Although the host described above with reference to FIG. 35 is described as providing a time delay to allow the user to adjust their pointing gesture to a different location on the interactive surface 1104 until the indicator 1194 is positioned at the intended location, those skilled in the art will appreciate that the host may alternatively monitor the movement of the indicator 1194 until the movement of the indicator 1194 has stopped, that is, the user has been pointing to the same location on the interactive surface (up to a defined distance threshold) for a defined period of time.

Although method 1140 is described above as calculating a 3D vector connecting the eye to the hand of the user in the event the user is positioned beyond the threshold distance and calculating a 3D vector connecting the elbow to the hand of the user in the event the user is positioned within the threshold distance, those skilled in the art will appreciate that the 3D vector may always be calculated by connecting the eye to the hand of the user or may always be calculated by connecting the elbow to the hand of the user, regardless of the distance the user is positioned away from the interactive surface.

Although the size and type of indicator displayed on the interactive surface is described as being dependent on the distance the user is positioned away from the interactive surface, those skilled in the art will appreciate that the same size and type of indicator may be displayed on the interactive surface regardless of the distance the user is positioned away from the interactive surface.

Those skilled in the art will appreciate that other methods for detecting a pointing gesture and the intended location of the pointing gesture are available. For example, in another embodiment, two infrared (IR) light sources are installed on the top bezel segment of the IWB at a fixed distance and are configured to point generally outwards. The IR light sources flood a 3D interactive space in front of the IWB with IR light. A hand-held device having an IR receiver for detecting IR light and a wireless module for transmitting information to the general purpose computing device connected to the IWB are provided to the user. When the user is pointing the hand-held device towards the interactive surface, the hand-held device detects the IR light transmitted from the IR light sources, and transmits an image of the captured IR light to the general purpose computing device. The general purpose computing device then calculates the position of the hand-held device using known triangulation, and calculates an approximate location on the interactive surface at which the hand-held device is pointing. An indicator is then applied similar to that described above, and, after a threshold period of time, is sent to the client devices connected to the collaboration session.

In another embodiment, an input event initiated by a user directing a laser pointer at the interactive surface may be detected by the host. In this embodiment, an imaging device is mounted on the boom assembly of the IWB, adjacent to the projector similar to that shown in FIGS. 28 and 29. When the user directs the laser pointer at a location on interactive surface casting a bright dot onto the interactive surface at an intended location, the imaging device captures an image of the interactive surface and transmits the captured image to the general purpose computing device for processing. The general purpose computing device processes the received image to determine the location of the bright dot. Similar to that described above, no indicator is displayed on the interactive surface of the host, however the pointer location is communicated to the participant client devices and an indicator is displayed on their display surfaces at the location of the detected bright dot.

Although input devices such as an IWB, keyboard, mouse, laser pointer, etc., are described above, those skilled in the art will appreciate that other types of input devices may be used. For example, in another embodiment an input device in the form of a microphone may be used.

In this embodiment, the interactive input system described above with reference to FIG. 1 comprises a microphone installed on the IWB or at a location near the IWB, and that is connected to the general purpose computing device. The general purpose computing device processes audio signals received from the microphone to detect input events based on a defined set of keywords. The defined set of keywords in this example comprises the words “here” and “there” although, as will be appreciated, other keywords may be employed. In the event the user says for example, the word “here” or “there” or other keyword in the set, the audio signal is detected by the general purpose computing device as an input event. Once a defined keyword is recognized, the interactive input system determines if a direct touch input has occurred or if a pointing gesture has been performed, and if so, an indicator is applied to the interactive surface 104 similar to that described above.

In another embodiment, the interactive input system described above with reference to FIG. 14 comprises a microphone installed on the IWB or at a location near the IWB, and that is connected to the general purpose computing device. Audio input into the microphone is transmitted to the general purpose computing device and distributed to the client devices connected to the collaboration session via the network. The general purpose computing device also processes the audio signals received from the microphone to detect input events based on a defined set of keywords. The defined set of keywords also comprises the words “here” and “there” although, as will be appreciated, other keywords may be employed. Once a defined keyword is recognized, the interactive input system determines if a direct touch input has occurred or if a pointing gesture has been performed, and if so, the general purpose computing device determines the location on the shared screen image to which an indicator is to be applied, and transmits the information in the form of an update message to the participant client devices.

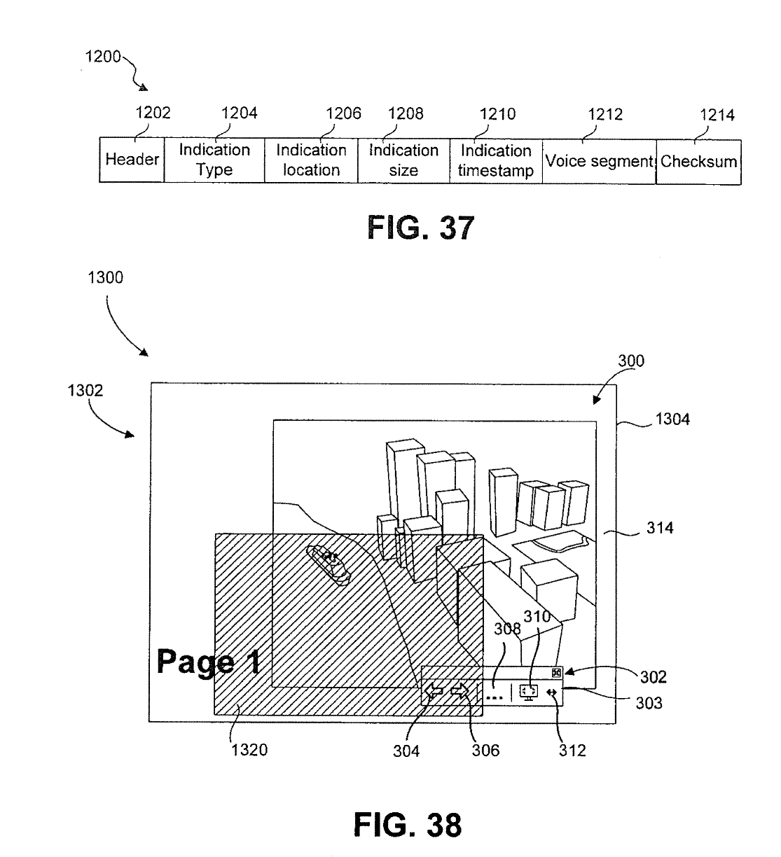

The architecture of the update message 1200 is shown in FIG. 37. As can be seen, the update message 1200 comprises a plurality of fields. In this example, the update message comprises header field 1202; indicator type field 1204; indicator location field 1206; indicator size field 1208; indicator timestamp field 1210; voice segment field 1212; and checksum field 1214. Header field 1202 comprises header information such as for example the source address (the host address), the target address (multicast address), etc. Indicator type field 1204 is a binary field indicating the type of indicator to be displayed: no indicator, temporary indicator, permanent indicator, etc. The indicator location field 1206 comprises the location (coordinates) of the indicator to be applied to the display surface, which is the mapped location of the pointing gesture or the location of the direct touch input, as described above. Indicator size field 1208 comprises the size information of the indicator to be applied to the display surface, which is determined by comparing the distance between the user and the IWB to a defined threshold as described above. Indication timestamp field 1210 comprises a timestamp value indicating the time that the audio was detected as an input event, that is, the time that the recognized keyword was detected. Voice segment field 1212 comprises the actual audio segment recorded by the microphone. Checksum field 1214 comprises the checksum of the message and is used by the remote client devices to verify if the received update message has any errors.

As will be appreciated, in the event the audio input does not comprise any keywords, that is, the user has not said one of the keywords, the indicator type field 1204 is set to “no indicator”. Since no indicator is required, the indicator size field 1208 and the indicator timestamp field 1210 are set to NULL values.

In the event the audio input comprises a recognized keyword such as “here” or “there”, the indicator type field 1204, indicator size field 1208 and indicator time stamp field 1210 are set to the appropriate values (described above).

Once the update message 1200 is received by a client device, the client device processes the received update message 1200 and checks the indicator type field 1204 to determine if an indicator is to be applied to its display surface. If the indicator type field 1204 is set to “no indicator”, indicator location field 1206 and indicator size field 1208 are ignored. The client device then extracts the actual audio segment from the voice segment field 1212 and plays the actual audio segment through a speaker associated therewith.

In the event the indicator type field 1204 is set to a value other than “no indicator”, the client device extracts the information from the indicator type field 1204, indicator location field 1206, indicator size field 1208, and indicator timestamp field 1210. The value of the indicator timestamp field 1210 provides the client device with time information of which the indicator is to be display on the display surface associated therewith. The client device then extracts the actual audio segment from the voice segment field 1212 and plays the actual audio segment through a speaker associated therewith. In this embodiment, the indicator is displayed on the display surface at the time indicated by the indicator timestamp field 1210.

Although the indicator is displayed on the display surface at the time indicated by the indicator timestamp field 1210, those skilled in the art will appreciate that the indicator may be displayed at a time different than that indicated in the timestamp field 1210. It will be appreciated that the different time is calculated based on the time indicated in the indicator timestamp field 1210. For example, the indicator may be displayed on the display surface with an animation effect, and the time for displaying the indicator is set to a time preceding the time indicated in the indicator timestamp field 1210 (i.e., five (5) seconds before the time indicated in the indicator timestamp field 1210).

Turning now to FIG. 38, the interactive surface of an interactive whiteboard forming part of another embodiment of an interactive input system 1300 is shown. Interactive input system 1300 is similar to interactive input system 100 described above, and comprises an IWB 1302 comprising an interactive surface 1304. In this embodiment, the interactive input system 1300 determines the size and type of pointer brought into contact with the IWB 1302, and compares the size of the pointer to a defined threshold. In the event the size of the pointer is greater than the defined threshold, the interactive input system ignores the pointer brought into contact with the interactive surface 1304. For example, in the event a user leans against the interactive surface 1304 of the IWB 1302, the input event will be ignored.

As shown in FIG. 38, the interactive surface 1304 displays a GUI 300 partitioned into an active control area 302 comprising a toolbar 303 having buttons 304 to 312, and an inactive area 314, as described above. A physical object, which in this example is a book 1320, contacts with the interactive surface 1304. It will be appreciated that book 1320 is not transparent; however for illustrative purposes book 1320 is illustrated as a semi-transparent rectangular box. The book 1320 covers a portion of the active control area 302 including toolbar buttons 304 and 306.

When the book 1320 contacts the interactive surface 1304, the book is detected as a pointer. As will be appreciated, if the contact was to be interpreted as an input event, processing the input event would yield unwanted results such as the selection of one of the toolbar buttons 304 and 306 on toolbar 303, and/or causing the presentation to randomly jump forwards and backwards between presentation slides.

To avoid unwanted input events, the general purpose computing device (not shown) associated with the interactive surface 1304 compares the size of a detected pointer to the defined threshold. In the event the size of a pointer is greater than the defined threshold, the pointer is ignored and no input event is created. It will be appreciated that the size of the pointer corresponds to one or more dimensions of the pointer such as for example the width of the pointer, the height of the pointer, the area of the pointer, etc. As shown in FIG. 38, in this example the size of the book 1320 is greater than the defined threshold, and thus the input event is ignored.

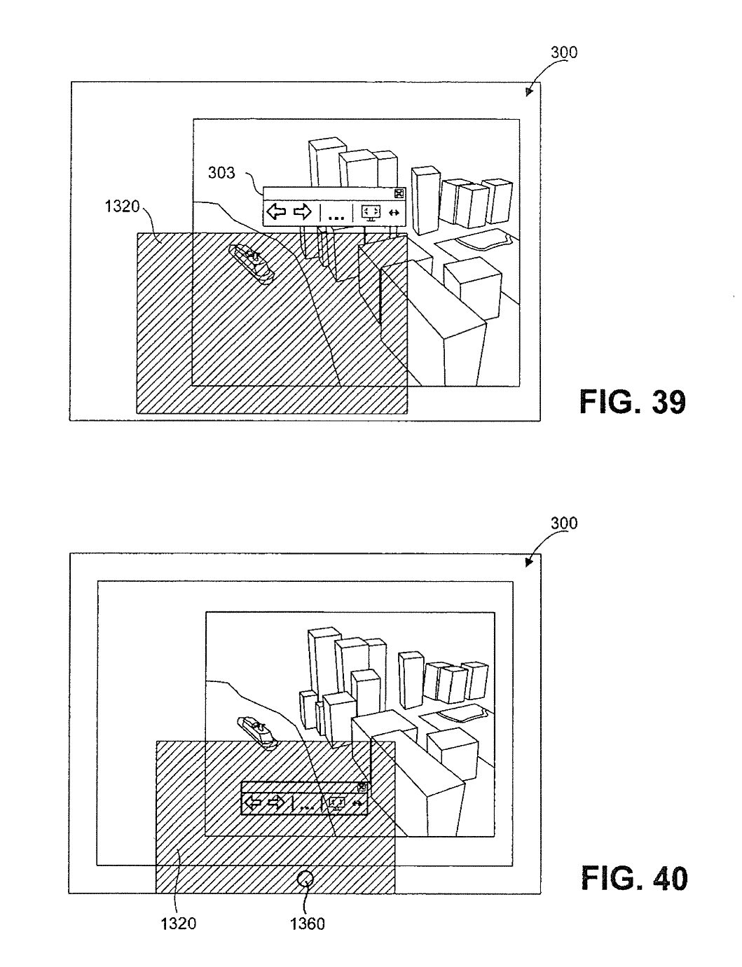

In the event a physical object such as for example the book 1320 shown in FIG. 38 is found to overlap at least a portion of the active control area 302 such as the toolbar 303 of the GUI 300, the general purpose computing device may move the toolbar 303 to another position on the GUI 300 such that the entire toolbar 303 is visible, that is, not blocked by the book 1320, as shown in FIG. 39.

Although it is described that unwanted input events are detected when a pointer greater than the defined threshold is determined to contact the interactive surface, those skilled in the art will appreciate that unwanted input events may be detected in a variety of ways. For example, in another embodiment, such as that shown in FIG. 40, the IWB 1302 comprises an infrared (IR) proximity sensor 1360 installed within one of the bezels. The proximity sensor 1360 communicates sensor data to the general purpose computing device (not shown). In the event a physical object such as for example a book 1320 is detected by the proximity sensor 1360, the general purpose computing device discards input events triggered by the book 1320.

Although in above embodiments, pointer contact events are not sent to the active application if the events occur in the inactive area, in some other embodiments, the general purpose computing device distinguishes the pointer contact events and only discards some pointer contact events (e.g., only the events representing tapping on the interactive surface) such that they are not sent to the active application if these events occur within the inactive area, while all other events are sent to the active application. In some related embodiments, users may choose which events should be discarded when occurring in the inactive area, via user preference settings. Further, in another embodiment, some input events, such as for example tapping detected on the active control area may also be ignored. In yet another embodiment some input events, such as for example tapping, may be interpreted as input events for specific objects within the active control area or inactive area.

Although it is described above that the interactive input system comprises at least one IWB, those skilled in the art will appreciate that alternatives are available. For example, in another embodiment, the interactive input system comprises a touch sensitive monitor used to monitor input events. In another embodiment, the interactive input system may comprise a horizontal interactive surface in the form of a touch table. Further, other types of IWBs may be used such as for example analog resistive, ultrasonic or electromagnetic touch surfaces. As will be appreciated, if an IWB in the form of an analog resistive board is employed, the interactive input system may be able to only identify a single touch input rather than multiple touch input.

In another embodiment, the IWB is able to detect pointers brought into proximity with the interactive surface without physically contacting the interactive surface. In this embodiment, the IWB comprises imaging assemblies having a field of view sufficiently large as to encompass the entire interactive surface and an interactive space in front of the interactive surface. The general purpose computing device processes image data acquired by each imaging assembly, and detects pointers hovering above, or in contact with, the interactive surface. In the event a pointer is brought into the proximity with the interactive surface without physically contacting the interactive surface, a hovering input event is generated. The hovering input event is then applied similar to an input event generated in the event a pointer contacts the interactive surface, as described above.

In another embodiment, in the event a hovering input event is generated at a position corresponding to the inactive area on a GUI displayed on the interactive surface, the hovering input event is applied similar to that described above. In the event a hovering input event is generated at a position corresponding to the active input area on the GUI displayed on the interactive surface, the hovering input event is ignored.

Although it is described above that an indicator (temporary or permanent) is only displayed on the display surface of viewers in collaboration sessions, those skilled in the art will appreciate that the indicator may also be displayed on the display surface of the host and/or annotator. In another embodiment, the displaying of indicators (temporary or permanent) may be an option provided to each client device, selectable by a user to enable/disable the display of indicators.

Although it is described that the interactive input system comprises an IWB having an interactive surface, those skilled in the art will appreciate that the IWB may not have an interactive surface. For example, the IWB shown in FIG. 32 may only detect gestures made within the 3D interactive space. In another embodiment, the interactive input system may be replaced by a touch input device such a for example a touchpad, which is separate from the display surface.

Although in above embodiments, indicators are shown only if the interactive input system is in the presentation mode, in some alternative embodiments, indicators may also be shown according to other conditions. For example, indicators may be shown regardless of whether or not the interactive input system is operating in the presentation mode.

Those skilled in the art will appreciate that the indicators described above may take a variety of shapes and forms, such as for example arrows, circles, squares, etc., and may also comprise animation effects such as ripple effects, colors or geometry distortions, etc.

Although it is described that the indicator applied to the client devices has the same shape for all client devices, those skilled in the art will appreciate that the type of indicator to be displayed may be adjustable by each user and thus, different indicators can be displayed on different client devices, based on the same input event. Alternatively, only one type of indicator may be displayed, regardless of which client device is displaying the indicator and regardless of whether or not the indicator is temporary or permanent.

In another embodiment, in the event more than one user is using the interactive input system, each user may be assigned a unique indicator to identify the input of each annotator. For example, a first user may be assigned a red-colored arrow and a second user may be assigned a blue-colored arrow. As another example, a first user may be assigned a star-shaped indicator and a second user may be assigned a triangle-shaped indicator.

Although the indicators are described as being either a permanent indicator or a temporary indicator, those skilled in the art will appreciate that all the indicators may be temporary indicators or permanent indicators.

Although embodiments have been described above with reference to the accompanying drawings, those of skill in the art will appreciate that variations and modifications may be made without departing from the scope thereof as defined by the appended claims.

What is claimed is:

1. A method comprising:
capturing at least one image of a three-dimensional (3D) space disposed in front of a display surface; and
processing the captured at least one image to detect a pointing gesture made by a user within the three-dimensional (3D) space and the position on the display surface to which the pointing gesture is aimed.

2. The method of claim 1 wherein said processing comprises:
identifying at least two reference points on the user associated with the pointing gesture;
calculating a 3D vector connecting the at least two reference points; and
extrapolating the 3D vector towards the display surface to identify the position thereon.

3. The method of claim 1 further comprising:
displaying an indicator on the display surface at the position.

4. The method of claim 3 wherein the indicator is one of a temporary indicator and a permanent indicator.

5. The method of claim 4 wherein the indicator is selected based on whether the position is aimed at an active area or inactive area of an image displayed on the display surface.

6. The method of claim 2 wherein the at least two reference points comprise the user's hand and an eye or the user's hand and elbow.

7. The method of claim 2 wherein the processing further comprises:
calculating a distance between the user and the display surface.

8. The method of claim 7 further comprising:
comparing the distance between the user and the display surface to a threshold.

9. The method of claim 8 wherein the distance between the user and the display surface determines the at least two reference points on the user that are identified.

10. The method of claim 9 wherein when the distance between the user and the display surface is greater than the threshold, one of the at least two reference points on the user corresponds to the user's eyes.

11. The method of claim 10 wherein the other of the at least two identified reference points on the user corresponds to the user's hand.

12. The method of claim 9 wherein when the distance between the user and the display surface is less than the threshold, one of the at least two identified reference points on the user corresponds to the user's elbow.

13. The method of claim 12 wherein the other of the at least two identified reference points on the user corresponds to the user's hand.

14. The method of claim 3 wherein the size of the indicator is dependent on the distance between the user and the display surface.

15. The method of claim 14 wherein when the distance between the user and the display surface is greater than a threshold, the indicator is displayed in a large format.

16. The method of claim 15 wherein when the distance between the user and the display surface is less than the threshold, the indicator is displayed in a small format.

17. The method of claim 7 further comprising:
comparing the distance between the user and the display surface to a threshold.

18. The method of claim 17 wherein when the distance between the user and the display surface is greater than the threshold, displaying an indicator on the display surface in a large format.

19. The method of claim 17 wherein when the distance between the user and the display surface is less than the threshold, displaying an indicator on the display surface in a small format.

20. An interactive input system comprising:
a display surface;
at least one imaging device configured to capture images of a three-dimensional (3D) space disposed in front of the display surface; and
processing structure configured to process the captured images to detect a user making a pointing gesture towards the display surface and the position on the display surface to which the pointing gesture is aimed.

21. The interactive input system of claim 20 wherein the processing structure is configured to identify at least two reference points on the user, calculate a 3D vector connecting the at least two reference points, and extrapolate the 3D vector towards the display surface to identify the position on the display surface.

22. The interactive input system of claim 21 wherein the processing structure is configured to display an indicator on the display surface at the position.

23. The interactive input system of claim 22 wherein the indicator is one of a temporary indicator and a permanent indicator.

24. The interactive input system of claim 23 wherein the indicator is selected based on whether the position is aimed at an active area or inactive area of an image displayed on the display surface.

25. The interactive input system of claim 22 wherein the processing structure is configured to calculate a distance between the user and the display surface.

26. The interactive input system of claim 25 wherein the distance between the user and the display surface determines the at least two reference points on the user that are identified.

27. The interactive input system of claim 26 wherein when the distance between the user and the display surface is greater than a threshold, one of the at least two identified reference points corresponds to a position of the user's eyes.

28. The interactive input system of claim 27 wherein the indicator is displayed in a large format.

29. The interactive input system of claim 26 wherein when the distance between the user and the display surface is less than a threshold, one of the at least two identified reference points corresponds to a position of the user's elbow.

30. The interactive input system of claim 29 wherein the indicator is displayed in a small format.

31. The interactive input system of claim 28 wherein the other of the at least two identified reference points corresponds to a position of the user's hand.

32. The interactive input system of claim 30 wherein the other of the at least two identified reference points corresponds to a position of the user's hand.

33. A method of manipulating a graphical user interface (GUI) displayed on a display surface comprising:
receiving an input event from an input device;
processing the input event to determine the location of the input event and the type of the input event;
comparing at least one of the location of the input event and the type of the input event to defined criteria; and
manipulating the GUI based on the result of the comparing.

34. The method of claim 33 further comprising:
partitioning the GUI into an active control area and an inactive area.

35. The method of claim 34 wherein said comparing is performed to determine if the location of the input event on the GUI corresponds to the active control area or the inactive area.

36. The method of claim 35 wherein the manipulating comprises applying an indicator to the GUI for display on the display surface at the location of the input event when the location of the input event corresponds to the inactive area.

37. The method of claim 36 wherein the comparing is performed to determine if the type of input event is a touch input event.

38. The method of claim 37 wherein when the input event is a touch input event, the comparing is further performed to determine a pointer type associated with the input event.

39. The method of claim 38 wherein the comparing is performed to determine if the pointer type associated with the input event is a first pointer type or a second pointer type.

40. The method of claim 39 wherein the manipulating comprises applying a temporary indicator to the GUI for display on the display surface at the location of the input event if the pointer type is the first pointer type.

41. The method of claim 40 wherein the first pointer type is a user's finger.

42. The method of claim 39 wherein the manipulating comprises applying a permanent indicator to the GUI for display on the display surface at the location of the input event if the pointer type is the second pointer type.

43. The method of claim 42 wherein the second pointer type is a pen tool.

44. The method of claim 35 wherein when the location of the input event on the GUI corresponds to the active control area, the comparing is performed to determine a type of active graphic object associated with the location of the input event.

45. The method of claim 44 wherein the manipulating comprises performing an update on the GUI displayed on the display surface based on the type of active graphic object.

46. The method of claim 45 wherein the type of graphic object is one of a menu, a toolbar, and a button.

47. The method of claim 37 wherein when the input event is a touch input event, the comparing is further performed to determine a pointer size associated with the input event.

48. The method of claim 47 wherein the further comparing is performed to compare the pointer size to a threshold.

49. The method of claim 48 wherein when the pointer size is less than the threshold, the indicator is of a first type.

50. The method of claim 48 wherein when the pointer size is less than the threshold, the indicator is of a small size.

51. The method of claim 48 wherein when the pointer is greater than the threshold, the indicator is of a second type.

52. The method of claim 48 wherein when the pointer is greater than the threshold, the indicator is of a large size.

53. The method of claim 38 wherein when the pointer type is a physical object and the location of the input event obstructs at least a portion of the active control area, the manipulating comprises moving the obstructed portion of the active control area to a new location on the GUI such that no portion of the active control area is obstructed by the physical object.

54. An interactive input system comprising:
a display surface on which a graphical user interface (GUI) is displayed;
at least one input device; and
processing structure configured to receive an input event from the at least one input device, determine the location of the input event and the type of the input event, compare at least one of the location of the input event and the type of the input event to defined criteria, and manipulate the GUI based on the result of the comparing.

55. The interactive input system of claim 54 wherein the processing structure partitions the GUI into an active control area and an inactive area.

56. The interactive input system of claim 55 wherein the processing structure compares the location of the input event to the defined criteria to determine if the location of the input event on the GUI corresponds to the active control area or the inactive area.

57. The interactive input system of claim 56 wherein during the manipulating, the processing structure applies an indicator to the GUI for display on the display surface at the location of the input event when the location of the input event corresponds to the inactive area.

58. The interactive input system of claim 56 wherein the processing structure compares the input event to the defined criteria to determine if the type of input event is a touch input event.

59. The interactive input system of claim 58 wherein when the input event is a touch input event, the processing structure determines a pointer type associated with the input event.

60. The interactive input system of claim 59 wherein the processing structure compares the input event to the defined criteria to determine if the pointer type associated with the input event is a first pointer type or a second pointer type.

61. The interactive input system of claim 60 wherein during the manipulating, the processing structure applies a temporary indicator to the GUI for display on the display surface at the location of the input event when the pointer type is the first pointer type.

62. The interactive input system of claim 61 wherein the first pointer type is a user's finger.

63. The interactive input system of claim 60 wherein during the manipulating, the processing structure applies a permanent indicator to the GUI for display on the display surface at the location of the input event when the pointer type is the second pointer type.

64. The interactive input system of claim 63 wherein the second pointer type is a pen tool.

65. The interactive input system of claim 56 wherein when the location of the input event on the GUI corresponds to the active control area, the processing structure compares the input event to the defined criteria to determine a type of active graphic object associated with the location of the input event.

66. The interactive input system of claim 65 wherein during the manipulating, the processing structure performs an update on the GUI displayed on the display surface based on the type of active graphic object.

67. The interactive input system of claim 65 wherein the type of graphic object is one of a menu, a toolbar, and a button.

68. The interactive input system of claim 58 wherein when the input event is a touch input event, the processing structure determines a pointer size associated with the input event.

69. The interactive input system of claim 68 wherein the processing structure compares the pointer size to a threshold.

70. The interactive input system of claim 69 wherein when the event that the pointer size is less than the threshold, the indicator is of a first type or a small size.

71. The interactive input system of claim 69 wherein when the pointer is greater than the threshold, the indicator is of a second type or a large size.

72. The interactive input system of claim 58 wherein when the pointer type is a physical object and the location of the input event obstructs at least a portion of the active control area, during the manipulating the processing structure moves the obstructed portion of the active control area to a new location on the GUI such that no portion of the active control area is obstructed by the physical object.

73. A method of manipulating a shared graphical user interface (GUI) displayed on a display surface of at least two client devices, one of the client devices being a host client device, the at least two client devices participating in a collaboration session, the method comprising:
receiving, at the host client device, an input event from an input device associated with an annotator device of the collaboration session;
processing the input event to determine the location of the input event and the type of the input event;
comparing at least one of the location of the input event and the type of the input event to defined criteria; and
manipulating the shared GUI based on the results of the comparing.

74. The method of claim 73 wherein the manipulating comprises applying an indicator to the shared GUI for display on the display surface of each of the at least two client devices.

75. The method of claim 73 further comprising determining if the host client device is the annotator device.

76. The method of claim 75 wherein when the host client device is the annotator device, applying an indicator to the shared GUI for display on the display surface of each of the at least two client devices with the exception of the host client device.

77. A method of applying an indicator to a graphical user interface (GUI) displayed on a display surface, the method comprising:
receiving an input event from an input device;
determining characteristics of said input event, the characteristics comprising at least one of the location of the input event and the type of the input event;
determining if the characteristics of the input event satisfies defined criteria; and
manipulating the GUI if the defined criteria is satisfied.

78. The method of claim 77 wherein the manipulating comprises applying an indicator to the GUI for display on the display surface.

79. The method of claim 77 wherein determining if the characteristics of the input event satisfies the defined criteria comprises comparing at least one of the characteristics of the input event to the defined criteria.

80. A method of processing an input event comprising:
receiving an input event from an input device;
determining characteristics of the input event, the characteristics comprising at least one of the location of the input event and the type of the input event;
determining an application program to which the input event is to be applied;
determining whether the characteristics of the input event satisfies defined criteria; and
sending the input event to the application program if the defined criteria is satisfied.
